(19) United States
(12) Patent Application Publication
(10) Pub. No.: US 2013/0236826 A1
(43) Pub. Date: Sep. 12, 2013

(54) TONER FOR ELECTROPHOTOGRAPHY, DEVELOPER AND METHOD OF PREPARING THE TONER

(71) Applicants: Keiji MAKABE, Shizuoka (JP); Masahide Yamada, Shizuoka (JP); Shinya Nakayama, Shizuoka (JP); Atsushi Yamamoto, Shizuoka (JP); Hideyuki Santo, Shizuoka (JP); Yukiko Nakajima, Kanagawa (JP); Daiki Yamashita, Kanagawa (JP); Kazumi Suzuki, Shizuoka (JP); Tatsuya Morita, Kanagawa (JP); Shingo Sakashita, Shizuoka (JP)

(72) Inventors: Keiji MAKABE, Shizuoka (JP); Masahide Yamada, Shizuoka (JP); Shinya Nakayama, Shizuoka (JP); Atsushi Yamamoto, Shizuoka (JP); Hideyuki Santo, Shizuoka (JP); Yukiko Nakajima, Kanagawa (JP); Daiki Yamashita, Kanagawa (JP); Kazumi Suzuki, Shizuoka (JP); Tatsuya Morita, Kanagawa (JP); Shingo Sakashita, Shizuoka (JP)

(21) Appl. No.: 13/709,185

(22) Filed: Dec. 10, 2012

(30) Foreign Application Priority Data
Mar. 7, 2012 (JP) 2012-049961

(51) Int. Cl. G03G 9/087

(52) U.S. Cl. CPC G03G 9/08728
USPC 430/109.4

(57) ABSTRACT

A toner for electrophotography, which is prepared by a method including dissolving or dispersing a toner composition including at least a binder resin, or binder resin and a binder resin precursor as a resin component; and a colorant in an organic solvent to form an oil phase; emulsifying or dispersing the oil phase in an aqueous medium to form an emulsion dispersion comprising emulsified particles; converging the emulsified particles to granulate mother toner particles, including controlling a temperature of the emulsion dispersion to control a circularity of the mother toner particles; and removing the organic solvent, wherein the resin component includes a crystalline resin in an amount not less than 50% by weight, and the mother toner particles have an average circularity of from 0.940 to 0.980.

### CROSS-REFERENCE TO RELATED APPLICATIONS

This patent application is based on and claims priority pursuant to 35 U.S.C. §119 to Japanese Patent Application No. 2012-049961, filed on Mar. 7, 2012 in the Japan Patent Office, the entire disclosure of which is hereby incorporated by reference herein.

### BACKGROUND OF THE INVENTION

1. Field of the Invention

The present invention relates to a toner for electrophotography, a developer using the toner and a method of preparing the toner.

2. Description of the Related Art

Conventionally, in an electrophotographic image forming apparatus or the like, an electrically or magnetically formed latent image is visualized with a toner for electrophotography (may be merely referred to as a “toner” hereinafter). For example, in electrophotography, an electrostatic latent image (latent image) is formed on a photoreceptor, followed by developing the latent image with the toner, to form a toner image. The toner image is typically transferred onto a transfer material such as paper, followed by fixing onto the transfer material. In the fixing image for fixing the toner image on the transfer paper, a thermal fixing system, such as a heating roller fixing system or heating belt fixing system, has been generally widely used because of its excellent energy efficiency.

Recently, there are increasing demands from the market for image forming apparatuses of high speed and energy saving, and therefore a toner having excellent low-temperature fixability and capable of providing high quality images is desired. To achieve the low-temperature fixability of the toner, the softening point of the binder resin contained in the toner needs to be low, but use of the binder resin having a low softening point tends to occur deposition of part of a toner image onto a surface of a fixing member during fixing, which will then be transferred to photocopy paper, which is so-called offset (also referred to as hot offset hereinafter). In addition to this, the heat resistance storage stability of the toner reduces, and therefore toner particles are fused to each other particularly in high temperature environments, which is so called blocking. Other than the above, use of the binder resin having a low softening point causes problems that the toner is fused to an inner area of an image developer, or to a carrier, and the toner tends to cause filming on a surface of a photoreceptor.

As for the technique for solving the aforementioned problems, it has been known that a crystalline resin is used as a binder resin of the toner. Specifically, the crystalline resin is capable of decreasing the softening point of the toner to around the melting point thereof by sharply softening at the melting point of the resin, while maintaining the heat resistance storage stability at the temperature equal to or lower than the melting point. Accordingly, use of the crystalline resin in the toner realizes both the low-temperature fixability and heat resistance storage stability of the toner.

Various methods of preparing a toner including a crystalline resin can be used. However, because of recent demands for higher quality images, particularly for high-definition color images, a toner is required to have smaller particle diameter and more sphericity. Therefore, instead of a toner having a wide particle diameter distribution and low productivity in a small size of from 2 to 8 μm prepared by kneading and pulverizing, a chemical toner obtained from granulation in an aqueous medium is being used.

Particularly, a suspension polymerization method placing a monomer, a polymerization initiator, a colorant, a charge controlling agent, etc. in an aqueous medium while stirring to form an oil drop, and then heating the oil drop to be polymerized to form a toner is widely used. In addition, an association method forming fine particles by emulsification or suspension polymerization, agglutinating the fine particles, and further melt-adhering the agglutinated fine particles to form toner particles is disclosed.

However, although the toner prepared by the polymerization or the association method can have a small particle diameter, a polyester resin or an epoxy resin preferably used in color toners cannot be used as a binder resin because main components thereof are limited to a radically polymerizable vinyl polymer for the method. Further, the polymerization method is difficult to reduce a VOC (volatile organic compound formed of unreacted monomers, etc.) and prepare a toner having a narrow particle diameter distribution.

Japanese Patents Nos. JP-3344214-B1 (HP-H09-319144-A) and JP-3455523-B1 (JP-2002-284881-A) disclose a dissolution suspension method dispersing a resin solution in which a polymerized resin is dissolved in an aqueous medium under the presence of a surfactant or a(n) (auxiliary) dispersant such as a hydrosoluble resin and a dispersion stabilizer such as an inorganic particulate material and a particulate resin, and removing a solvent by heating and depressurizing to form toner particles. These methods are capable of not only downsizing the particle diameter of a toner as the polymerization method is, but also using a polyester resin effectively used in full-color process needing transparency and smoothness of images after fixed, having a wide selection of the binder resin.

In the dissolution suspension method, dispersed particles tend to inevitably be spheronized due to interface tension of a droplet when dispersed. A spherical toner has good fluidity although having a small particle diameter and is advantageously used to design a hopper and an image developer, e.g., a torque for rotating a develop roller can be smaller, but is difficult to remove by some cleaning methods. Namely, the surface of a photoreceptor after a toner image is transferred therefrom is cleaned by means such as a blade, a fur brush or a magnetic brush. Particularly, the blade is typically used in many cases because of having a simple structure and good cleanability. The spherical toner rotates between the blade and the photoreceptor and thrusts into a gap therebetween, and has a serious problem of being difficult to remove.

In order to use the chemical toner prepared by the dissolution suspension method in the blade cleaning method, Japanese Patent No. JP-4607228-B1(JP-2010-055117-A) discloses a method of breaking structural viscosity of a resin solution when emulsifying and dispersing the resin solution with a shearing force, and releasing the shearing force to restore the structural viscosity to form non-spherical agglutinated particles. In addition, Japanese published unexamined application No. JP-2011-33911-A discloses a method of flowing an emulsified dispersion along a heated tube wall to form non-spherical agglutinated particles.

However, the former controls the shape of a toner with the mechanical shearing force and the structural viscosity and is difficult to fine-tune after restoring the structural viscosity. The latter needs a heating tube besides the emulsifying and dispersing equipment, and has a problem of productivity

Because of these reasons, a need exist for a toner formed of a mother toner having a controllable shape, having high low-temperature fixability, heat resistance storage stability and cleanability, and producing high-quality.

### SUMMARY OF THE INVENTION

Accordingly, one object of the present invention to provide a toner formed of a mother toner having a controllable shape, having high low-temperature fixability, heat resistance storage stability and cleanability, and producing high-quality.

Another object of the present invention to provide a method of preparing the toner.

A further object of the present invention to provide a developer using the toner.

These objects and other objects of the present invention, either individually or collectively, have been satisfied by the discovery of a toner for electrophotography, which is prepared by a method comprising:

dissolving or dispersing a toner composition comprising at least a binder resin, or

binder resin and a binder resin precursor as a resin component; and a colorant in an organic solvent to form an oil phase;

emulsifying or dispersing the oil phase in an aqueous medium to form an emulsion dispersion comprising emulsified particles;

converging the emulsified particles to granulate mother toner particles, comprising controlling a temperature of the emulsion dispersion to control a circularity of the mother toner particles; and

removing the organic solvent,

wherein the resin component comprises a crystalline resin in an amount not less than 50% by weight, and the mother toner particles have an average circularity of from 0.940 to 0.980.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of two-component image developer of the image forming apparatus of the present invention;

FIG. 2 is a schematic view illustrating an embodiment of the process cartridge of the present invention;

FIG. 3 is a is a schematic view illustrating an embodiment of the tandem image forming apparatus of the present invention; and

FIG. 4 is an amplified view of a part of the image forming apparatus in FIG. 3.

### DETAILED DESCRIPTION OF THE INVENTION

The present invention provides a toner formed of a mother toner having a controllable shape, having high low-temperature fixability, heat resistance storage stability and cleanability, and producing high-quality.

More particularly, the present invention relates to a toner for electrophotography, which is prepared by a method comprising:

dissolving or dispersing a toner composition comprising at least a binder resin, or binder resin and a binder resin precursor as a resin component; and a colorant in an organic solvent to form an oil phase;

emulsifying or dispersing the oil phase in an aqueous medium to form an emulsion dispersion comprising emulsified particles;

converging the emulsified particles to granulate mother toner particles, comprising controlling a temperature of the emulsion dispersion to control a circularity of the mother toner particles; and

removing the organic solvent,

wherein the resin component comprises a crystalline resin in an amount not less than 50% by weight, and the mother toner particles have an average circularity of from 0.940 to 0.980.

The toner as well as a method of preparing the toner of the present invention are explained in detail.

### [Preparation of Emulsion Dispersion]

### 1) Oil Phase

The oil phase is formed by dissolving or dispersing toner materials including at least a binder resin, or binder resin and a binder resin precursor, and a colorant; and other components such as organic-modified layered inorganic mineral, a release agent, a charge controlling agent and an active hydrogen-containing compound reactable with the binder resin precursor when necessary in an organic solvent.

### <Organic Solvent>

As for the organic solvent used for dissolving or dispersing the toner composition containing the binder resin, binder resin precursor and colorant, a volatile organic solvent having a boiling point of lower than 100° C. is preferable because it can be easily removed in the later step.

Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone, or in combination. Among them, the ester-based solvent such as methyl acetate, and ethyl acetate, the aromatic solvent such as toluene, and xylene, and the halogenated hydrocarbon such as methylene chloride, 1,2-dichloroethane, chloroform, and carbon tetrachloride are preferable.

The solid content of the oil phase, which is obtained by dissolving and/or dispersing the toner composition containing the binder resin or binder resin precursor and the colorant is preferably from 40 to 80% by weight. The excessively high solid content thereof causes difficulties in dissolving or dispersing, and increases the viscosity of the oil phase which is difficult to handle. The excessively low solid content thereof leads to a low yield of the toner.

The toner composition excluding the resin, such as the colorant and the organic-modified layered inorganic mineral, and master batches thereof may be separately dissolved and/or dispersed in an organic solvent, and then mixed with the resin solution and/or dispersion.

### <Resin Component>

The resin component is appropriately selected depending on the intended purpose without any limitation, provided that the resin component contains a crystalline resin in an amount of 50% by weight or greater, specifically, a main component of the resin component is substantially the crystalline resin.

An amount of the crystalline resin in the resin component is appropriately selected depending on the intended purpose without any limitation, provided that it is 50% by weight or greater. The amount of the crystalline resin is preferably 65% by weight or greater, more preferably 80% by weight or greater, and even more preferably 95% by weight or greater for attaining the maximum effect of the crystalline resin in both of low fixability and heat resistance storage stability. When the amount thereof is less than 50% by weight, the thermal sharpness of the resin component in the viscoelasticity of the toner cannot be exhibited, which makes it difficult to attain both low fixability and heat resistance storage stability of the resulting toner.

The binder resin precursor of the resin component is preferably a crystalline resin. The binder resin preferably includes a crystalline resin, and may include a crystalline resin and a non-crystalline resin together.

The resin component preferably includes the binder resin precursor in an amount of from 0 to 70 parts by weight, and more preferably from 10 to 50 parts by weight. When greater than 70 parts by weight, the oil phase has a large viscosity, resulting in occasional emulsion or dispersion inefficiency.

In the present specification, as for the term “crystalline,” a resin having a ratio (softening point/maximum peak temperature of heat of melting) of 0.80 to 1.55 is defined as a “crystalline resin,” where the ratio is a ratio of a softening point of the resin as measured by a elevated flow tester to a maximum peak temperature of heat of melting the resin as measured by a differential scanning calorimeter (DSC). The “crystalline resin” has properties that it is sharply softened by heat.

Moreover, as for “non-crystalline,” a resin having a ratio (softening point/maximum peak temperature of heat of melting) of greater than 1.55 is defined as “non-crystalline resin.” The “non-crystalline resin” has properties that it is gradually softened by heat.

The softening points of the binder resin and toner can be measured by means of an elevated flow tester (e.g., CFT-500D, from Shimadzu Corporation). As a sample, 1 g of the binder resin or toner is used. The sample is heated at the heating rate of 6° C./min., and at the same time, load of 1.96 Mpa is applied by a plunger to extrude the sample from a nozzle having a diameter of 1 mm and length of 1 mm, during which an amount of the plunger of the flow tester pushed down relative to the temperature is plotted. The temperature at which half of the sample is flown out is determined as a softening point of the sample.

The maximum peak temperatures of heat of melting the binder resin and toner can be measured by a differential scanning calorimeter (DSC) (e.g., TA-60WS and DSC-60 of Shimadzu Corporation). A sample provided for a measurement of the maximum peak temperature of heat of melting is subjected to a pretreatment. Specifically, the sample is melted at 130° C., followed by cooled from 130° C. to 70° C. at the rate of 1.0° C./min. Next, the sample was cooled from 70° C. to 10° C. at the rate of 0.5° C./min. Then, the sample is heated at the heating rate of 20° C./min. to measure the endothermic and exothermic changes by DSC, to thereby plot “absorption or evolution heat capacity” verses “temperature” in a graph. In the graph, the endothermic peak temperature appeared in the temperature range from 20° C. to 100° C. is determined as an endothermic peak temperature, Ta*. In the case where there are a few endothermic peaks within the aforementioned temperature range, the temperature of the peak at which the absorption heat capacity is the largest is determined as Ta*. Thereafter, the sample is stored for 6 hours at the temperature that is (Ta*−10)° C., followed by storing for 6 hours at the temperature that is (Ta*−15)° C. Next, the sample is cooled to 0° C. at the cooling rate of 10° C./min., and then heated at the heating rate of 20° C./min. to measure the endothermic and exothermic changes by means of DSC, creating a graph in the same manner as the above. In the graph, the temperature corresponding to the maximum peak of the absorption or evolution heat capacity is determined as the maximum peak temperature of heat of melting.

### <<Crystalline Resin>>

The crystalline resin is appropriately selected depending on the intended purpose without any limitation, and examples thereof include a polyester resin, a polyurethane resin, a polyurea resin, a polyamide resin, a polyether resin, a vinyl resin, and a modified crystalline resin. These may be used alone, or in combination. Among them, the polyester resin, polyurethane resin, polyurea resin, polyamide resin, and polyether resin are preferable, the resin having at least either of a urethane skeleton or a urea skeleton is preferable, and a composite resin containing a straight-chain polyester resin, and a straight-chain polyester resin is more preferable.

As for the resin containing at least either of the urethane skeleton or the urea skeleton, for example, the aforementioned polyurethane resin, the aforementioned polyurea resin, a urethane-modified polyester resin, and a urea-modified polyester resin are preferably included. The urethane-modified polyester resin is a resin obtained through a reaction between a polyester resin having a terminal isocyanate group, and polyol. The urea-modified polyester resin is a resin obtained through a reaction between a polyester resin having a terminal isocyanate group, and amines.

The maximum peak temperature of heat of melting the crystalline resin is preferably from 45 to 70° C., more preferably from 53 to 65° C., and even more preferably from 58 to 62° C. for attaining both low-temperature fixability and heat resistance storage stability of the resulting toner. When the maximum peak temperature thereof is lower than 45° C., the resulting toner has desirable low-temperature fixability, but insufficient heat resistance storage stability. When the maximum peak temperature thereof is higher than 70° C., the toner has conversely desirable heat resistance storage stability, but insufficient low-temperature fixability.

The crystalline resin has a ratio (softening point/maximum peak temperature of heat of melting) of from 0.80 to 1.55, preferably from 0.85 to 1.25, more preferably from 0.90 to 1.20, and even more preferably from 0.90 to 1.19, where the ratio is a ratio of a softening point of the crystalline resin to a maximum peak temperature of heat of melting the crystalline resin. The smaller value of the ratio is preferable as the smaller the value is more sharply the resin is softened, which can realize to achieve both low-temperature fixability and heat resistance storage stability of the resulting toner.

Regarding the viscoelasticity of the crystalline resin, storage elastic modulus G′ of the crystalline resin at the temperature that is the maximum peak temperature of heat of melting+20° C. is preferably 5.0×10⁶ Pa·s or lower, more preferably from 1.0×10¹ Pa·s to 5.0×10⁵ Pa·s, and even more preferably from 1.0×10¹ Pa·s to 1.0×10⁴ Pa·s. Moreover, loss elastic modulus G″ of the crystalline resin at the temperature that is the maximum peak temperature of heat of melting+20° C. is preferably 5.0×10⁶ Pa·s or lower, more preferably from 1.0×10¹ Pa·s to 5.0×10⁵ Pa·s, and even more preferably from 1.0×10¹ Pa·s to 1.0×10⁴ Pa·s. In view of the viscoelasticity of the toner of the present invention, the values of G′ and G″ at the temperature the maximum peak temperature of heat of melting+20° C. falling into the range of from 1.0×10³ Pa·s to 5.0×10⁶ Pa·s is preferable for giving the fixing strength and hot offset resistance to the resulting toner. Considering that the values of G′ and G″ increase as the colorant or layered inorganic mineral is dispersed in the binder resin, the viscoelasticity of the crystalline resin are preferably within the aforementioned range.

The aforementioned viscoelasticity of the crystalline resin can be achieved by adjusting a mixing ratio between a crystalline monomer and non-crystalline monomer constituting the binder resin, or the molecular weight of the binder resin. For example, the value of G′ (Ta+20) degreases as a proportion of the crystalline monomer increases in the monomers constituting the binder resin.

Dynamic viscoelastic values (storage elastic modulus G′, loss elastic modulus G″) of the resin and toner can be measured by means of a dynamic viscoelastometer (e.g., ARES of TA Instruments Japan Inc.). The measurement is carried out with a frequency of 1 Hz. A sample is formed into a pellet having a diameter of 8 mm, and a thickness of 1 mm to 2 mm, and the pellet sample is fixed to a parallel plate having a diameter of 8 mm, followed by stabilizing at 40° C. Then, the sample is heated to 200° C. at the heating rate of 2.0° C./min. with frequency of 1 Hz (6.28 rad/s), and strain of 0.1% (in a strain control mode) to thereby measure dynamic viscoelastic values of the sample.

The weight-average molecular weight Mw of the crystalline resin is preferably from 2,000 to 100,000, more preferably from 5,000 to 60,000, and even more preferably from 8,000 to 30,000 in view of fixability of the resulting toner. When the weight-average molecular weight thereof is smaller than 2,000, the resulting toner is likely to exhibit insufficient hot offset resistance. When the weight-average molecular weight thereof is larger than 100,000, low-temperature fixability of the resulting toner tends to be degraded.

In the embodiment of the present invention, the weight-average molecular weight (Mw) of the binder resin can be measured by means of a gel permeation chromatography (GPC) measuring device (e.g., GPC-8220GPC of Tosoh Corporation). As for a column used for the measurement, TSKgel Super HZM-H, 15 cm, three connected columns (of Tosoh Corporation) are used. The resin to be measured is formed into a 0.15% by weight solution using tetrahydrofuran (THF) (containing a stabilizer, from Wako Chemical Industries, Ltd.), and the resulting solution is subjected to filtration using a filter having a pore size of 0.2 μm, from which the filtrate is provided as a sample. The THF sample solution is injected in an amount of 100 μL into the measuring device, and the measurement is carried out at a flow rate of 0.35 mL/min. in the environment having the temperature of 40° C. For the measurement of the molecular weight distribution of the sample, a molecular weight distribution of the sample is calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene are used. As the detector, a refractive index (RI) detector is used.

### <<<Polyester Resin>>>

As for the polyester resin, for example, a polycondensate polyester resin synthesized from polyol and polycarboxylic acid, a lactone ring-opening polymerization product, and polyhydroxycarboxylic acid are included. Among them, the polycondensate polyester resin synthesized from polyol and polycarboxylic acid is preferable in view of exhibition of crystallinity.

### —Polyol—

The polyol includes, for example, diol, trihydric to octahydric or higher polyol.

The diol is appropriately selected depending on the intended purpose without any limitation, and examples thereof include: aliphatic diol such as straight-chain aliphatic diol, branched-chain aliphatic diol; C4-C36 alkylene ether glycol; C4-C36 alicyclic diol; alkylene oxide (abbreviated as “AO” hereinafter) of the above-listed alicyclic diol; AO adducts of bisphenols; polylactonediol; polybutadienediol; and diol having a functional group, such as diol having a carboxyl group, diol having a sulfonic acid group or sulfamine group, salts thereof, and diols having other functional groups. Among them, C2-C36 aliphatic diol is preferable, and the straight-chain aliphatic diol is more preferable. These may be used alone, or in combination.

An amount of the straight-chain aliphatic diol is preferably 80 mol % or greater, more preferably 90 mol % or greater relative to the total amount of the diols. Use of the straight-chain aliphatic diol in an amount of 80 mol % or greater is preferable as the crystallinity of the resin is enhanced, both low-temperature fixability and heat resistance storage stability are desirably provided to the resulting resin, and the hardness of the resin tends to be increased.

The straight-chain aliphatic diol is appropriately selected depending on the intended purpose without any limitation, and examples thereof include ethylene glycol, 1,3-propanediol, 1,4-butanediol, 1,5-pentanediol, 1,6-hexanediol, 1,7-heptanediol, 1,8-octanediol, 1,9-nanonediol, 1,10-decanediol, 1,11-undecanediol, 1,12-dodecanediol, 1,13-tridecanediol, 1,14-tetradecanediol, 1,18-octadecanediol, and 1,20-eicosanediol. Among them, ethylene glycol, 1,3-propanediol, 1,4-butanediol, 1,6-hexanediol, 1,9-nanonediol, and 1,10-decanediol are preferable, because they are readily available.

The C2-C36 branched-chain aliphatic diol is appropriately selected depending on the intended purpose without any limitation, and examples thereof include 1,2-propylene glycol, butanediol, hexanediol, octanediol, decanediol, dodecanediol, tetradecanediol, neopentyl glycol, and 2,2-diethyl-1,3-propanediol.

The C4-C36 alkylene ether glycol is appropriately selected depending on the intended purpose without any limitation, and examples thereof include diethylene glycol, triethylene glycol, dipropylene glycol, polyethylene glycol, polypropylene glycol, and polytetramethylene ether glycol.

The C4-C36 alicyclic diol is appropriately selected depending on the intended purpose without any limitation, and examples thereof include 1,4-cyclohexanedimethanol, and hydrogenated bisphenol A.

The alkylene oxide (abbreviated as “AO” hereinafter) of the above-listed alicyclic diol is appropriately selected depending on the intended purpose without any limitation, and examples thereof include adducts (number of moles added: 1 to 30) of ethylene oxide (may be abbreviated as “EO” hereinafter), propylene oxide (may be abbreviated as “PO” hereinafter), butylene oxide (may be abbreviated as “BO”).

The bisphenols are appropriately selected depending on the intended purpose without any limitation, and examples thereof include AO (e.g., EO, PO, and BO) adducts (number of moles added: 2 to 30) of bisphenol A, bisphenol F, and bisphenol S.

The polylactone diol is appropriately selected depending on the intended purpose without any limitation, and examples thereof include poly(ε-caprolactone) diol.

The diol having a carboxyl group is appropriately selected depending on the intended purpose without any limitation, and examples thereof include: C6-C24 dialkylol alkanoic acid such as 2,2-dimethylol propionic acid (DMPA), 2,2-dimethylol butanoic acid, 2,2-dimethylol heptanoic acid, and 2,2-dimethylol octanoic acid.

The diol having a sulfonic acid group or sulfaminic acid group is appropriately selected depending on the intended purpose without any limitation, and examples thereof include: N,N-bis(2-hydroxyalkyl)sulfamic acid (where the alkyl group is C1-C6 group) and AO adducts thereof (where AO is EO or PO, and the number of moles of AO added is 1 to 6), such as N,N-bis(2-hydroxyethyl)sulfamic acid, and N,N-bis(2-hydroxyethyl)sulfamic acid PO (2 mol) adduct; and bis(2-hydroxyethyl)phosphate.

The neutralized salt group contained in the diol having a neutralized salt group is appropriately selected depending on the intended purpose without any limitation, and examples thereof include C3-C30 tertiary amine (e.g., triethyl amine), and alkali metal (e.g., sodium salt).

Among them, the C2-C12 alkylene glycol, diol having a carboxyl group, AO adduct of bisphenols, and any combinations thereof are preferable.

Moreover, the trihydric to octahydric or higher polyol, which is optionally used, is appropriately selected depending on the intended purpose without any limitation, and examples thereof include: C3-C36 trihydric to octahydric or higher polyhydric aliphatic alcohol such as alkane polyol, and its intramolecular or intermolecular dehydrate (e.g., glycerin, trimethylol ethane, trimethylol propane, pentaerythritol, sorbitol, sorbitan, and polyglycerin), saccharide and derivatives thereof (e.g., sucrose, and methylglucoside); AO adduct (number of moles added: 2 to 30) of trisphenols (e.g., trisphenol PA); AO adduct (number of moles added: 2 to 30) of a novolak resin (e.g., phenol novolak, and cresol novolak); and acryl polyol such as a copolymer of hydroxyethyl (meth)acrylate and other vinyl-based monomer. Among them, the trihydric to octahydric or higher aliphatic polyhydric alcohol, and AO adduct of the novolak resin are preferable, and the AO adduct of the novolak resin is more preferable.

### —Polycarboxylic Acid—

As for the polycarboxylic acid, for example, dicarboxylic acid, and trivalent to hexavalent, or higher polycarboxylic acid are included.

The dicarboxylic acid is appropriately selected depending on the intended purpose without any limitation, and examples thereof include: aliphatic dicarboxylic acid such as a straight-chain aliphatic dicarboxylic acid, and branched-chain dicarboxylic acid; and aromatic dicarboxylic acid. Among them, the straight-chain aliphatic dicarboxylic acid is preferable. The aliphatic dicarboxylic acid is appropriately selected depending on the intended purpose without any limitation, and examples thereof preferably include: C4-C36 alkane dicarboxylic acid such as succinic acid, adipic acid, sebacic acid, azelaic acid, dodecane dicarboxylic acid, octadecane dicarboxylic acid, and decyl succinic acid; C4-C36 alkene dicarboxylic acid such as alkenyl succinic acid (e.g., dodecenyl succinic acid, pentadecenyl succinic acid, octadecenyl succinic acid), maleic acid, fumaric acid, citraconic acid; and C6-C40 alicyclic dicarboxylic acid such as dimer acid (e.g., dimeric lenoleic acid).

The aromatic dicarboxylic acid is appropriately selected depending on the intended purpose without any limitation, and examples thereof preferably include C8-C36 aromatic dicarboxylic acid such as phthalic acid, isophthalic acid, terephthalic acid, t-butyl isophthalic acid, 2,6-naphthalene dicarboxylic acid, and 4,4′-biphenyl dicarboxylic acid. Examples of the optionally used trivalent to hexavalent or higher polycarboxylic acid include C9-C20 aromatic polycarboxylic acid such as trimellitic acid, and pyromellitic acid.

Note that, as the dicarboxylic acid or trivalent to hexavalent or higher polycarboxylic acid, acid anhydrides or C1-C4 lower alkyl ester (e.g., methyl ester, ethyl ester, and isopropyl ester) of the above-listed acids may be used.

Among the above-listed dicarboxylic acids, a use of the aliphatic dicarboxylic acid (preferably, adipic acid, sebacic acid, dodecane dicarboxylic acid, terephthalic acid, isophthalic acid, etc.) alone is particularly preferable, but a copolymer of the aliphatic dicarboxylic acid and the aromatic dicarboxylic acid (preferably, terephthalic acid, isophthalic acid, or t-butyl isophthalic acid; or lower alkyl ester of these aromatic dicarboxylic acids) is also preferably used. In this case, the amount of the aromatic dicarboxylic acid in a copolymer is preferably 20 mol % or smaller.

### —Lactone Ring-Opening Polymerization Product—

The lactone ring-opening polymerization product is appropriately selected depending on the intended purpose without any limitation, and examples thereof include a lactone ring-opening polymerization product obtained by subjecting lactones (e.g., C3-C12 monolactone (having one ester group in a ring), such as β-propiolactone, γ-butyrolactone, δ-valerolactone, and c-caprolactone) to ring-opening polymerization using a catalyst (e.g., metal oxide, and an organic metal compound); and a lactone ring-opening polymerization product containing a terminal hydroxy group obtained by subjecting C3-C12 monolactones to ring-opening polymerization using glycol (e.g., ethylene glycol, and diethylene glycol) as an initiator. The C3-C12 monolactone is appropriately selected depending on the intended purpose without any limitation, but it is preferably c-caprolactone in view of crystallinity.

The lactone ring-opening polymerization product may be selected from commercial products, and examples of the commercial products include highly crystalline polycaprolactone such as H1P, H4, H5, and H7 of PLACCEL series from Daicel Corporation.

### —Polyhydroxycarboxylic Acid—

The preparation method of the polyhydroxycarboxylic acid is appropriately selected depending on the intended purpose without any limitation, and examples thereof include a method in which hydroxycarboxylic acid such as glycolic acid, and lactic acid (e.g., L-lactic acid, D-lactic acid, and racemic lactic acid) is directly subjected to a dehydration-condensation reaction; and a method in which C4-C12 cyclic ester (the number of ester groups in the ring is 2 to 3), which is an equivalent to a dehydration-condensation product between 2 or 3 molecules of hydroxycarboxylic acid, such as glycolide or lactide (e.g., L-lactide acid, D-lactide, and racemic lactic acid) is subjected to a ring-opening polymerization using a catalyst such as metal oxide and an organic metal compound. The method using ring-opening polymerization is preferable because of easiness in adjusting a molecular weight of the resultant.

Among the cyclic esters listed above, L-lactide and D-lactide are preferable in view of crystallinity. Moreover, terminals of the polyhydroxycarboxylic acid may be modified to have a hydroxyl group or carboxyl group.

### <<<Polyurethane Resin>>>

As for the polyurethane resin, a polyurethane resin synthesized from polyol (e.g., diol, trihydric to octahydric or higher polyol) and polyisocyanate (e.g., diisocyanate, and trivalent or higher polyisocyanate) is included. Among them, the polyurethane resin synthesized from the diol and the diisocyanate is preferable.

As for the diol and trihydric to octahydric or higher polyol, those mentioned as the diol and trihydric to octahydric or higher polyol listed in the description of the polyester resin can be used.

### —Polyisocyanate—

As for the polyisocyanate, for example, diisocyanate, and trivalent or higher polyisocyanate are included.

The diisocyanate is appropriately selected depending on the intended purpose without any limitation, and examples thereof include aromatic diisocyanates, aliphatic diisocyanates, alicyclic diisocyanates, and aromatic aliphatic diisocyanates. Among them, preferable examples include the C6-C20 aromatic diisocyanate (the number of the carbon atoms excludes other than those contained in NCO groups, which is the same as follows), the C2-C18 aliphatic diisocyanate, C4-C15 alicyclic diisocyanate, C8-C15 aromatic aliphatic diisocyanate, and modified products (e.g., modified products containing a urethane group, carboxylmide group, allophanate group, urea group, biuret group, uretdione group, uretimine group, isocyanurate group, or oxazolidone group) of the preceding diisocyanates, and a mixture of two or more of the preceding diisocyanates. Optionally, trivalent or higher isocyanate may be used in combination.

The aromatic diisocyanates are appropriately selected depending on the intended purpose without any limitation, and examples thereof include 1,3- and/or 1,4-phenylene diisocyanate, 2,4- and/or 2,6-tolylenediisocyanate (TDI), crude TDI, 2,4′- and/or 4,4′-diphenyl methane diisocyanate (MDI), crude MDI (e.g., a phosgenite product of crude diaminophenyl methane (which is a condensate between formaldehyde and aromatic amine (aniline) or a mixture thereof, or condensate of a mixture of diaminodiphenyl methane and a small amount (e.g., 5% by weight to 20% by weight) of trivalent or higher polyamine) and polyallylpolyisocyanate (PAPI)), 1,5-naphthalene diisocyanate, 4,4′,4″-triphenylmethane triisocyanate, and m- and p-isocyanatephenylsulfonyl isocyanate.

The aliphatic diisocyanates are appropriately selected depending on the intended purpose without any limitation, and examples thereof include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethylcaproate, bis(2-isocyanatoethyl)fumarate, bis(2-isocyanatoethyl)carbonate, and 2-isocyanatoethyl-2,6-diisocyanatohexanoate.

The alicyclic diisocyanates are appropriately selected depending on the intended purpose without any limitation, and examples thereof include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornanediisocyanate. The aromatic aliphatic diisocyanate is appropriately selected depending on the intended purpose without any limitation, and examples thereof include m- and p-xylene diisocyanate (XDI), and α,α,α′,α′-tetramethylxylene diisocyanate (TMXDI).

Moreover, the modified product of the diisocyanate is appropriately selected depending on the intended purpose without any limitation, and examples thereof include modified products containing a urethane group, carboxylmide group, allophanate group, urea group, biuret group, uretdione group, uretimine group, isocyanurate group, or oxazolidone group. Specific examples thereof include: modified products of diisocyanate such as modified MDI (e.g., urethane-modified MDI, carbodiimide-modified MDI, and trihydrocarbylphosphate-modified MDI), and urethane-modified TDI (e.g., isocyanate-containing prepolymer); and a mixture of two or more of these modified products of diisocyanate (e.g., a combination of modified MDI and urethane-modified TDI).

Among these diisocyanates, C6-C15 aromatic diisocyanate (where the number of carbon atoms excludes those contained in NCO groups, which will be the same as follows), C4-C12 aliphatic diisocyanate, and C4-C15 alicyclic diisocyanate are preferable, and TDI, MDI, HDI, hydrogenated MDI, and IPDI are particularly preferable.

### <<<Polyurea Resin>>>

As for the polyurea resin, a polyurea resin synthesized from polyamine (e.g., diamine, and trivalent or higher polyamine) and polyisocyanate (e.g., diisocyanate, and trivalent or higher polyisocyanate) is included. Among them, the polyurea resin synthesized from the diamine and the diisocyanate is preferable.

As for the diisocyanate and trivalent or higher polyisocyanate, those listed as the diisocyanate and trivalent or higher polyisocyanate in the description of the polyurethane resin can be used.

### —Polyamine—

As for the polyamine, for example, diamine, and trivalent or higher polyamine are included.

The diamine is appropriately selected depending on the intended purpose without any limitation, and examples thereof include aliphatic diamines, and aromatic diamines. Among them, C2-C18 aliphatic diamines, and C6-C20 aromatic diamines are preferable. With this, the trivalent or higher amines may be used in combination, if necessary.

The C2-C18 aliphatic diamines are appropriately selected depending on the intended purpose without any limitation, and examples thereof include: C2-C6 alkylene diamine, such as ethylene diamine, propylene diamine, trimethylene diamine, tetramethylene diamine, and hexamethylene diamine; C4-C18 alkylene diamine, such as diethylene triamine, iminobispropyl amine, bis(hexamethylene) triamine, triethylene tetramine, tetraethylene pentamine, and pentaethylene hexamine; C1-C4 alkyl or C2-C4 hydroxyalkyl substitution products of the alkylene diamine or polyalkylene diamine, such as dialkylaminopropylamine, trimethylhexamethylene diamine, aminoethylethanolamine, 2,5-dimethyl-2,5-hexamethylene diamine, and methyl isobispropyl amine; C4-C15 alicyclic diamine, such as 1,3-diaminocyclohexane, isophorone diamine, menthane diamine, and 4,4′-methylene dichlorohexane diamine (hydrogenated methylene dianiline); C4-C15 heterocyclic diamine, such as piperazine, N-aminoethyl piperazine, 1,4-diaminoethyl piperazine, 1,4-bis(2-amino-2-methylpropyl)piperazine, 3,9-bis(3-aminopropyl)-2,4,8,10-tetraoxapiro[5,5]undecane; and C8-C15 aromatic ring-containing aliphatic amines such as xylylene diamine, and tetrachloro-p-xylylene diamine.

The C6-C20 aromatic diamines are appropriately selected depending on the intended purpose without any limitation, and examples thereof include: unsubstituted aromatic diamine such as 1,2-, 1,3- and 1,4-phenylenediamine, 2,4′- and 4,4′-diphenyl methanediamine, crude diphenyl methanediamine (e.g., polyphenyl polymethylene polyamine), diaminodiphenyl sulfone, benzidine, thiodianiline, bis(3,4-diaminophenyl)sulfone, 2,6-diaminopyridine, m-aminobenzylamine, triphenylmethane-4,4′,4″-triamine, and naphthylene diamine; aromatic diamine containing a C1-C4 nuclear substituted alkyl group such as 2,4- and 2,6-tolylenediamine, crude tolylenediamine, diethyltolylenediamine, 4,4′-diamino-3,3′-dimethyldiphenyl methane, 4,4′-bis(o-toluidine), dianisidine, diaminoditolylsulfone, 1,3-dimethyl-2,4-diaminobenzene, 1,3-dimethyl-2,6-diaminobenzene, 1,4-diisopropyl-2,5-diaminobenzene, 2,4-diaminomesitylene, 1-methyl-3,5-diethyl-2,4-diaminobenzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenyl methane, 3,5-diethyl-3′-methyl-2′,4-diaminodiphenyl methane, 3,3′-diethyl-2,2′-diaminodiphenyl methane, 4,4′-diamino-3,3′-dimethyldiphenyl methane, 3,3′,5,5′-tetraethyl-4,4′-diaminobenzophenone, 3,3′,5,5′-tetraethyl-4,4′-diaminodiphenyl ether, and 3,3′,5,5′-tetraisopropyl-4,4′-diaminodiphenylsulfone; mixtures of isomers of the unsubstituted aromatic diamine and/or aromatic diamine containing a C1-C4 nuclear substituted alkyl group at various mixing ratios; methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, and 3-dimethoxy-4-aminoaniline; aromatic diamine containing a nuclear substituted electron-withdrawing group (e.g., halogen such as Cl, Br, I, and F; an alkoxy group such as a methoxy group and ethoxy group; and a nitro group), such as 4,4′-diamino-3,3′-dimethyl-5,5′-dibromo-diphenyl methane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylene bis(2-iodoaniline), 4,4′-methylenebis(2-bromoaniline), 4,4′-methylenebis(2-fluoroaniline), and 4-aminophenyl-2-chloroaniline; and aromatic diamine containing a secondary amino group (e.g., part of or entire primary amino groups of the unsubstituted aromatic diamine, aromatic diamine containing a C1-C4 nuclear substituted alkyl group, mixture of isomers thereof at various mixing ratios, and aromatic diamine containing a nuclear substituted electron-withdrawing group are substituted with secondary amino group using lower alkyl groups such as a methyl group, and ethyl group), such as 4,4′-di(methylamino)diphenyl methane, and 1-methyl-2-methylamino-4-aminobenzene.

As for the diamine, other than those listed above, polyamide polyamine such as low molecular polyamide polyamine obtained by condensation of dicarboxylic acid (e.g., dimer acid) and excess (2 moles or more per mole of acid) of the polyamine (e.g., the alkylene diamine, and the poly alkylene polyamine); and polyether polyamine such as hydride of cyanoethylated product of polyetherpolyol (e.g., polyalkylene glycol) are included.

### <<<Polyamide Resin>>>

As for the polyamide resin, a polyamide resin synthesized from polyamine (e.g., diamine, and trivalent or higher polyamine), and polycarboxylic acid (e.g., dicarboxylic acid, and trivalent to hexavalent or higher polycarboxylic acid) is included. Among them, the polyamide resin synthesized from diamine and dicarboxylic acid is preferable.

As for the diamine and trivalent or higher polyamine, those listed as the diamine and trivalent or higher polyamine in the description of the polyurea resin can be used.

As for the dicarboxylic acid and trivalent to hexavalent or higher polycarboxylic acid, those listed as the dicarboxylic acid and trivalent to hexavalent or higher polycarboxylic acid in the description of the polyester resin can be used.

### <<<Polyether Resin>>>

The polyether resin is appropriately selected depending on the intended purpose without any limitation, and examples thereof include crystalline polyoxyalkylene polyol.

The preparation method of the crystalline polyoxyalkylene polyol is appropriately selected from the conventional methods known in the art depending on the intended purpose without any limitation, and examples thereof include: a method in which chiral AO is subjected to ring-opening polymerization using a catalyst that is commonly used for a polymerization of AO (e.g., a method described in Journal of the American Chemical Society, 1956, Vol. 78, No. 18, pp. 4787-4792); and a method in which inexpensive racemic AO is subjected to ring-opening polymerization using a catalyst that is a complex having a three-dimensionally bulky unique chemical structure.

As for the method using the unique complex, a method using a compound in which a lanthanoide complex and organic aluminum are in contact as a catalyst (e.g., a method described in Japanese published unexamined application No. JP-H11-12353-A), and a method in which bimetal-μ-oxoalkoxide and a hydroxyl compound are reacted in advance (e.g., a method described in Japanese published unexamined application No. JP-2001-521957-A) have been known.

As for the method for obtaining crystalline polyoxyalkylene polyol having extremely high isotacticity, a method using a salen complex (e.g., the method described in Journal of the American Chemical Society, 2005, Vol. 127, No. 33, pp. 11566-11567) has been known. For example, by using glycol or water as an initiator in the course of a ring-opening polymerization of chiral AO, polyoxyalkylene glycol containing a terminal hydroxyl group, and having isotacticity of 50% or higher is yielded. The polyoxyalkylene glycol having isotacticity of 50% or higher may be the one whose terminal group may be modified to have a carboxyl group. Note that, the isotacticity of 50% or higher generally results in crystallinity. As for the glycol, the aforementioned diol is included. As for the carboxylic acid used for the carboxy-modification, the aforementioned dicarboxylic acid is included.

As for AO used for the production of the crystalline polyoxyalkylene polyol, C3-C9 AO is included. Examples thereof include PO, 1-chlorooxetane, 2-chlorooxetane, 1,2-dichlorooxetane, epichlorohydrin, epibromohydrin, 1,2-BO, methyl glycidyl ether, 1,2-pentyleneoxide, 2,3-pentyleneoxide, 3-methyl-1,2-butyleneoxide, cyclohexene oxide, 1,2-hexyleneoxide, 3-methyl-1,2-pentyleneoxide, 2,3-hexyleneoxide, 4-methyl-2,3-pentyleneoxide, allylglycidyl ether, 1,2-heptyleneoxide, styrene oxide, and phenylglycidyl ether. Among these AOs, PO, 1,2-BO, styrene oxide, and cyclohexene oxide are preferable, PO, 1,2-BO, and cyclohexene oxide are more preferable. These AOs may be used alone or in combination.

The isotacticity of the crystalline polyoxyalkylene polyol is preferably 70% or higher, more preferably 80% or higher, even more preferably 90% or higher, and particularly preferably 95% or higher, in view of high sharp melt properties and blocking resistance of the resulting crystalline polyether resin.

The isotacticity can be calculated by the method described in Macromolecules, Vol. 35, No. 6, pp. 2389-2392 (2002), and can be obtained in the following manner.

About 30 mg of a measuring sample is weight and taken into a sample tube for ¹³C-NMR having a diameter of 5 mm, and about 0.5 mL of a deuteration solvent is added thereto to dissolve the sample therein, to thereby prepare a sample for analysis. The deuteration solvent for use is not particularly limited, and appropriately selected from solvents capable of dissolving the sample. Examples of such deuteration solvent include deuterated chloroform, deuterated toluene, deuterated dimethylsulfoxide, and deuterated dimethyl formamide.

Three signals of ¹³C-NMR derived from a methine group are respectively appeared around the syndiotactic value (S) of 75.1 ppm, heterotactic value (H) of 75.3 ppm, and isotactic value (I) of 75.5 ppm.

The isotacticity is calculated by the following equation 1:

Isotacticity (%)=[I/(I+S+H)]×100 Equation 1

In the equation 1, I is an integral value of the isotactic signal, S is an integral value of the syndiotactic signal, and H is an integral value of the heterotactic signal.

### <<<Vinyl Resin>>>

The vinyl resin is appropriately selected depending on the intended purpose without any limitation, provided that it has crystallinity, but it is preferably one containing, in its constitutional unit, a crystalline vinyl monomer and optionally a non-crystalline vinyl monomer.

The crystalline vinyl monomer is appropriately selected depending on the intended purpose without any limitation, and examples thereof preferably include a straight-chain alkyl (meth)acrylate having C12-050 alkyl group (C12-050 straight-chain alkyl group is a crystalline group), such as lauryl(meth)acrylate, tetradecyl(meth)acrylate, stearyl(meth)acrylate, eicosyl(meth)acrylate, and behenyl(meth)acrylate.

The non-crystalline vinyl monomer is appropriately selected depending on the intended purpose without any limitation, but it is preferably a vinyl monomer having a molecular weight of 1,000 or smaller. Examples thereof include styrenes, (meth)acryl monomer, a carboxyl group-containing vinyl monomer, other vinyl ester monomers, and aliphatic hydrocarbon vinyl monomer. These may be used alone, or in combination.

The styrenes are appropriately selected depending on the intended purpose without any limitation, and examples thereof include styrene, and alkyl styrene having a C1-C3 alkyl group.

The (meth)acryl monomer is appropriately selected depending on the intended purpose without any limitation, and examples thereof include: (meth)acrylate where the alkyl group has 1 to 11 carbon atoms and branched alkyl(meth)acrylate where the alkyl group has 12 to 18 carbon atoms, such as methyl(meth)acrylate, ethyl(meth)acrylate, butyl(meth)acrylate, and 2-ethylhexyl (meth)acrylate; hydroxylalkyl(meth)acrylate where the alkyl group has 1 to 11 carbon atoms, such as hydroxylethyl(meth)acrylate; and alkylamino group-containing (meth)acrylate where the alkyl group contains 1 to 11 carbon atoms, such as dimethylaminoethyl(meth)acrylate, and diethylaminoethyl(meth)acrylate.

The carboxyl group-containing vinyl monomer is appropriately selected depending on the intended purpose without any limitation, and examples thereof include: C3-C15 monocarboxylic acid such as (meth)acrylic acid, crotonic acid, and cinnamic acid; C4-C15 dicarboxylic acid such as maleic acid (anhydride), fumaric acid, itaconic acid, and citraconic acid; dicarboxylic acid monoester, such as monoalkyl (C1-C18) ester of dicarboxylic acid (e.g., maleic acid monoalkyl ester, fumaric acid monoalkyl ester, itaconic acid monoalkyl ester, and citraconic acid monoalkyl ester).

The aforementioned other vinyl ester monomers are appropriately selected depending on the intended purpose without any limitation, and examples thereof include: C4-C15 aliphatic vinyl ester such as vinyl acetate, vinyl propionate, and isopropenyl acetate; C8-C50 unsaturated carboxylic acid polyhydric (dihydric to trihydric or higher) alcohol ester such as ethylene glycol di(meth)acrylate, propylene glycol di(meth)acrylate, neopentyl glycol di(meth)acrylate, trimethylolpropane tri(meth)acrylate, 1,6-hexanediol diacrylate, and polyethylene glycol di(meth)acrylate; and C9-C15 aromatic vinyl ester such as methyl-4-vinylbenzoate.

The aliphatic hydrocarbon vinyl monomer is appropriately selected depending on the intended purpose without any limitation, and examples thereof include: C2-C10 olefin such as ethylene, propylene, butene, and octene; and C4-C 10 diene such as butadiene, isoprene, and 1,6-hexadiene.

### <<<Binder Resin Precursor>>>

The binder resin precursor is appropriately selected depending on the intended purpose without any limitation, provided that it is a crystalline resin having a functional group reactive with an active hydrogen group. Examples of the modified crystalline resin include a crystalline polyester resin, crystalline polyurethane resin, crystalline polyurea resin, crystalline polyamide resin, crystalline polyether resin, and crystalline vinyl resin, all of which contain a functional group reactive with an active hydrogen group. The modified crystalline resin is reacted with a compound having an active hydrogen group (e.g., a resin containing an active hydrogen group, and a crosslinking or elongation agent containing an active hydrogen) during the production of a toner, so that the molecular weight of the resulting resin is increased to form a binder resin. Accordingly, the modified crystalline resin can be used as a binder resin precursor in the production of the toner.

Note that, the binder resin precursor denotes a compound capable of undergoing an elongation reaction or crosslink reaction, including the aforementioned monomers, oligomers, and modified resins or oligomers having a functional group reactive with an active hydrogen group for constituting the binder resin. The binder resin precursor may be a crystalline resin or a non-crystalline resin, provided that it satisfies these conditions. Among them, the binder resin precursor is preferably the modified crystalline resin containing an isocyanate group at least at a terminal thereof, and it is preferred that the binder resin precursor undergo an elongation and/or crosslink reaction with an active hydrogen group during granulating toner particles by dispersing and/or emulsifying in an aqueous medium, to thereby form a binder resin.

As for the binder resin formed from the binder resin precursor in the aforementioned manner, a crystalline resin obtained by an elongation reaction and/or crosslink reaction of the modified resin containing a functional group reactive with an active hydrogen group and the compound containing an active hydrogen group is preferable. Among them, a urethane-modified polyester resin obtained by an elongation and/or crosslink reaction of the polyester resin containing a terminal isocyanate group and the polyol; and a urea-modified polyester resin obtained by an elongation reaction and/or crosslink reaction of the polyester resin containing a terminal isocyanate group and the amines are preferable.

The functional group reactive with an active hydrogen group is appropriately selected depending on the intended purpose without any limitation, and examples thereof include functional groups such as an isocyanate group, an epoxy group, a carboxylic group, and an acid chloride group. Among them, the isocyanate group is preferable in view of the reactivity and stability.

The compound containing an active hydrogen group is appropriately selected depending on the intended purpose without any limitation, provided that it contains an active hydrogen group. In the case where the functional group reactive with an active hydrogen group is an isocyanate group, for example, the compound containing an active hydrogen group includes compounds containing a hydroxyl group (e.g., alcoholic hydroxyl group and phenolic hydroxyl group), an amino group, a carboxyl group, and a mercapto group as the active hydrogen group. Among them, the compound containing an amino group (e.g., amines) is particularly preferable in view of the reaction speed.

The amines are appropriately selected depending on the intended purpose without any limitation, and examples thereof include phenylene diamine, diethyl toluene diamine, 4,4′ diaminodiphenylmethane, 4,4′-diamino-3,3′dimethyldicyclohexylmethane, diamine cyclohexane, isophorone diamine, ethylene diamine, tetramethylene diamine, hexamethylene diamine, diethylene triamine, triethylene tetramine, ethanol amine, hydroxyethyl aniline, aminoethylmercaptan, aminopropylmercaptan, amino propionic acid, and amino caproic acid. Moreover, a ketimine compound and oxazoline compound where amino groups of the preceding amines are blocked with ketones (e.g., acetone, methyl ethyl ketone, and methyl isobutyl ketone) are also included as the examples of the amines.

The crystalline resin may be a block copolymer resin having a crystalline segment and a non-crystalline segment, and the crystalline resin can be used as the crystalline segment. A resin used for forming the non-crystalline segment is appropriately selected depending on the intended purpose without any limitation, and examples thereof include a polyester resin, a polyurethane resin, a polyurea resin, a polyamide resin, a polyether resin, a vinyl resin (e.g., polystyrene, and styreneacryl-based polymer), and an epoxy resin.

Since the crystalline segment is preferably at least one selected from the group consisting of a polyester resin, a polyurethane resin, a polyurea resin, a polyamide resin, and a polyether resin, in view of compatibility, the resin used for forming the non-crystalline segment is also preferably selected from a polyester resin, a polyurethane resin, a polyurea resin, a polyamide resin, a polyether resin, and a composite resin thereof, more preferably a polyurethane resin, or a polyester resin. The formulation of the non-crystalline segment can be any combinations of materials which is appropriately selected depending on the intended purpose without any limitation, provided that it is a non-crystalline resin. Examples of a monomer for use include the aforementioned polyol, the aforementioned polycarboxylic acid, the aforementioned polyisocyanate, the aforementioned polyamine, and the aforementioned AO.

### <<Non-Crystalline Resin>>

The non-crystalline resin is appropriately selected from conventional resins known in the art depending on the intended purpose without any limitation, provided that it is non-crystalline. Examples thereof include: homopolymer of styrene or substitution thereof (e.g., polystyrene, poly-p-styrene, and polyvinyl toluene), styrene copolymer (e.g., styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer); other resins (e.g., a polymethyl methacrylate resin, a polybutyl methacrylate resin, a polyvinyl chloride resin, a polyvinyl acetate resin, a polyethylene resin, a polypropylene resin, a polyester resin, an epoxy resin, an epoxy polyol resin, a polyurethane resin, a polyamide resin, a polyvinyl butyral resin, a polyacrylic acid resin, a rosin resin, a modified rosin resin, a terpene resin, an aliphatic or alicyclic hydrocarbon resin, an aromatic petroleum resin); and modified products of the preceding resins to contain a functional group reactive an active hydrogen group. These may be used alone, or in combination.

### <Colorant>

The colorant is appropriately selected from conventional dyes and pigments known in the art depending on the intended purpose without any limitation, and examples thereof include: carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used alone, or in combination.

A color of the colorant is appropriately selected depending on the intended purpose without any limitation, and examples thereof include a colorant for black, and color colorants for magenta, cyan, and yellow. These may be used alone, or in combination.

Examples of the colorant for black include: carbon black (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Examples of the colorant for magenta include: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209, 211; C.I. Pigment Violet 19; and C.I. Vat Red 1, 2, 10, 13, 15, 23, 29, 35.

Examples of the colorant for cyan include: C.I. Pigment Blue 2, 3, 15, 15:1, 15:2, 15:3, 15:4, 15:6, 16, 17, 60; C.I. Vat Blue 6; C.I. Acid Blue 45, a copper phthalocyanine pigment, a copper phthalocyanine pigment in which 1 to 5 methyl phthalimide groups have been introduced to the phthalocyanine skeleton, Green 7, and Green 36.

Examples of the colorant for yellow include: C.I. Pigment Yellow 0-16, 1, 2, 3, 4, 5, 6, 7, 10, 11, 12, 13, 14, 15, 16, 17, 23, 55, 65, 73, 74, 83, 97, 110, 151, 154, 180; C.I. Vat Yellow 1, 3, 20; and C.I. Pigment Orange 36.

An amount of the colorant in the toner is appropriately selected depending on the intended purpose without any limitation, but it is preferably from 1 to 15% by weight, and more preferably from 3 to 10% by weight. When the amount thereof is smaller than 1% by weight, the tinting strength reduces. When the amount thereof is greater than 15% by weight, a dispersion failure of the pigment particles occurs in the toner, which may cause reduction in tinting strength and electric characteristics of the toner.

The colorant may form a composite with a resin for master batch, and may be used as a master batch. The resin for master batch is appropriately selected from those known in the art depending on the intended purpose without any limitation, and examples thereof include polymer of styrene or substitution thereof, styrene copolymer, a polymethyl methacrylate resin, a polybutyl methacrylate resin, a polyvinyl chloride resin, a polyvinyl acetate resin, a polyethylene resin, a polypropylene resin, a polyester resin, an epoxy resin, an epoxypolyol resin, a polyurethane resin, a polyamide resin, a polyvinyl butyral, a polyacrylic acid resin, rosin, modified rosin, a terpene resin, an aliphatic hydrocarbon resin, an alicyclic hydrocarbon resin, an aromatic petroleum resin, chlorinated paraffin, and paraffin wax. These may be used alone, or in combination.

Examples of the polymer of styrene or substitution thereof include a polyester resin, a polystyrene resin, a poly-p-chlorostyrene resin, and polyvinyl toluene resin. Examples of the styrene copolymer include styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer.

As for the resin for the master batch, the binder resin of the present invention, such as the aforementioned crystalline resin, can be used without any problem.

The master batch can be prepared by mixing and kneading the colorant with the resin for the master batch. In the mixing and kneading, an organic solvent may be used for improving the interactions between the colorant and the resin. Moreover, the master batch can be prepared by a flashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### <Other Components>

The toner of the present invention may contain other components than the binder resin and colorant if necessary, provided that the obtainable effect of the invention is not impaired. Examples of the aforementioned components include an organic-modified layered inorganic mineral, a release agent, a charge controlling agent, an external additive, a fluidity improver, a cleanability improver, and a magnetic material.

<<Organic-Modified Layered Inorganic Mineral>>

The organic-modified layered inorganic mineral is an organic-modified layered inorganic mineral in which at least part of ions present between layers of a layered inorganic mineral are modified with organic ions. The layered inorganic mineral is a layered inorganic mineral formed with layers having the average thickness of several nanometers laminated. The term “modified” means introducing organic ions to ions present between layers of the layered inorganic mineral, specifically, it means substituting at least part of ions present between layers of the layered inorganic mineral with organic ions, or further introducing organic ions between layers of the layered inorganic mineral, or both. In the broad sense, the “modified” means intercalation.

Since the toner of the present invention, which contains the binder resin containing the crystalline resin in an amount of 50% by weight or greater, contains the organic-modified layered inorganic mineral in which at least part of ions present between layers of the layered inorganic mineral are modified with organic ions, the stress resistance is provided to the resulting toner to the same level as the conventional toner, as well as preventing occurrences of image damages during transportation due to recrystallization just after thermal fixing, and formations of output images with insufficient hardness.

The layered inorganic mineral moreover exhibits the maximum effect by located adjacent to a surface of a toner particle, but in the present invention, it has been found that the organic-modified layered inorganic mineral are uniformly aligned adjacent to the surface of the toner particle without any space therebetween. Because of this aligning structure, the structural viscosity of the binder resin present adjacent to the surface of the toner particle is effectively increased, so that the binder resin sufficiently protect the resulting image even though the image is such an image having low hardness of the resin just after fixing. In addition, the organic-modified layered inorganic mineral can efficiently exhibit its effect with a small amount thereof, and therefore it is considered that it hardly affect the fixability of the toner.

The presence and state of the organic-modified layered inorganic mineral in the toner can be confirmed by cutting a sample, which has been prepared by embedding toner particles in an epoxy resin or the like, by a micro microtome or ultramicrotome, and observing the cross-sections of the toner particles in the cut surface of the sample under a scanning electron microscope (SEM) or the like. In the case of the observation by SEM, it is preferred that the sample be confirmed in a reflection electron image, as the presence of the organic-modified layered inorganic mineral can be observed with a strong contrast. Alternatively, a sample prepared by embedding toner particles in an epoxy resin or the like is cut with ion beams by means of FIB-STEM (HD-2000, Hitachi, Ltd.), and the cross-sections of the toner particles in the cut surface of the sample may be observed. In this case, visual observation is preferable rather than observing a reflection electron image because of easiness.

Moreover, the expression “adjacent to the surface(s) of the toner particle(s)” used in the present specification is defined as the region(s) of the toner particle(s) that is in depth of 0 nm to 300 nm from the outer surface(s) of the toner particle(s) in the observation image of cross-section(s) of toner particle(s) obtained by cut a sample in which toner particles are embedded in an epoxy resin or the like by means of a micro microtome, ultramicrotome, or FIB-STEM, where the cross-section of the toner particle is a cut surface of the toner particle containing a center of the toner particle.

The layered inorganic mineral is appropriately selected depending on the intended purpose without any limitation, and examples thereof include a smectite clay mineral (e.g., montmorillonite, saponite, and hectorite), kaolin clay mineral (e.g., kaolinite), bentonite, attapulgite, magadiite, and kenemite. These may be used alone, or in combination.

The organic-modified layered inorganic mineral is appropriately selected depending on the intended purpose without any limitation, and examples thereof include an organic-modified layered inorganic mineral in which at least part of ions (organic cation or organic anion) present between layers of the layered inorganic mineral are modified with organic ions (organic cation or organic anion). Among them, the organic-modified layered inorganic mineral in which at least part of ions present between layers of a smectite clay mineral having a smectite basic crystal structure are modified with organic cations is preferable because it can be stably dispersed in the area adjacent to surfaces of toner particles. The organic-modified layered inorganic mineral in which at least part of ions present between layers of montmorillonite are modified with organic cations, and the organic-modified layered inorganic mineral in which at least part of ions present between layers of bentonite are modified with organic cations are particularly preferable.

The modification of part of the ions present between layers of the layered inorganic mineral with organic ions in the organic-modified layered inorganic mineral can be confirmed by has chromatography weight spectroscopy (GCMS). For example, it preferably include a method in which the binder resin in the toner, which is a sample, is dissolved in a solvent to prepare a solution, the resulting solution is subjected to filtration to obtain solids, and the obtained solids are thermally decomposed by means of a thermal decomposition device, to thereby determine the organic material by GCMS. Specifically, there is a method in which as the thermal decomposition device, Py-2020D (from Frontier Laboratories Ltd.) is used to perform thermal decomposition at 550° C., followed by performing the determination by means of a GCMS device, QP5000 (from Shimadzu Corporation).

Examples of the organic-modified layered inorganic mineral further include the layered inorganic compound in which metal anions are introduced by substituting part of bivalent metals of the layered inorganic mineral with trivalent metals, and at least part of the metal anions are further substituted with organic anions.

As for the organic-modified layered inorganic mineral, commercial products may be used. Examples of the commercial products thereof include: octanium-18 bentonite, such as BENTONE 3, BENTONE 38, BENTONE 38V (all from Elements Specialties); TIXOGEL VP (from ROCKWOOD ADDITIVES LTD.), CLAYTONE 34, CLAYTONE 40, and CLAYTONE XL (all from Southern Clay Products Inc.); stearalkonium bentonite such as BENTONE 27(from Elements Specialties), TIXOGEL LG (from ROCKWOOD ADDITIVES LTD.), and CLAYTONE AF (from Southern Clay Products Inc.); octanium-18/benzalkonium bentonite, such as CLAYTONE HT, CLAYTONE PS, and CLAYTONE APA (all from Southern Clay Products Inc.); organic-modified montmorillonite, such as CLAYTONE HY (from Southern Clay Products Inc.); and organic-modified smectite, such as LUCENTITE SPN (from Kobo Products, Inc.). Among them, CLAYTONE AF, and CLAYTONE APA are particularly preferable.

The organic-modified layered inorganic mineral is particularly preferably the one in which DHT-4A (from Kyowa Chemical Industry Co., Ltd.) is modified with a compound containing the organic ion represented by R₁(OR₂)nOSO₃M (where R₁ is a C13 alkyl group, R₂ is a C2-C6 alkylene group, n is an integer of 2 to 10, and M is a monovalent metal element). Examples of the compound containing the organic ion represented by R₁(OR₂)nOSO₃M include HITENOL 330T (from Dai-ichi Kogyo Seiyaku Co., Ltd.).

The organic-modified layered inorganic mineral may be mixed with a resin to form a master batch that is a composite thereof with the resin, and may be used as the master batch. The resin is appropriately selected from those known in the art depending on the intended purpose without any limitation.

An amount of the organic-modified layered inorganic mineral in the toner is preferably from 0.1 to 3.0% by weight, more preferably from 0.5 to 2.0% by weight, and even more preferably from 1.0 to 1.5% by weight. When the amount thereof is less than 0.1% by weight, the effect of the layered inorganic mineral may not be effectively exhibited. When the amount thereof is greater than 3.0% by weight, low-temperature fixability may be inhibited.

The organic ion modification agent, which contains organic ions and is a compound capable of modifying at least part of the ions present between layers of the layered inorganic mineral with organic ions, is appropriately selected depending on the intended purpose without any limitation. Examples thereof include: a quaternary alkyl ammonium salt; a phosphonium salt; an imidazolium salt; sulfate having a skeleton of C1-C44 branched, non-branched, or cyclic alkyl, C1-C22 branched, non-branched, or cyclic alkenyl, C8-C32 branched, non-branched, or cyclic alkoxy, or C2-C22 branched, non-branched, or cyclic hydroxyalkyl ethyleneoxide, or propylene oxide; a sulfonic acid salt having the aforementioned skeleton; a carboxylic acid salt having the aforementioned skeleton; and a phosphoric acid salt having the aforementioned skeleton. Among them, a quaternary alkyl ammonium salt, and a carboxylic acid salt having an ethylene oxide skeleton are preferable, and the quaternary alkyl ammonium salt is particularly preferable. These may be used alone, or in combination.

Examples of the quaternary alkyl ammonium include trimethylstearyl ammonium, dimethylstearylbenzyl ammonium, dimethyloctadecyl ammonium, and oleylbis(2-hydroxyethyl)methyl ammonium.

### <<Release Agent>>

The release agent is appropriately selected from those known in the art without any limitation, and examples thereof include wax, such as carbonyl group-containing wax, polyolefin wax, and a long-chain hydrocarbon. These may be used alone, or in combination. Among them, the carbonyl group-containing wax is preferable.

Examples of the carbonyl group-containing wax include polyalkanoic acid ester, polyalkanol ester, polyalkanoic acid amide, polyalkyl amide, and dialkyl ketone.

Examples of the polyalkanoic acid ester include carnauba wax, montan wax, trimethylolpropane tribehenate, pentaerythritol tetrabehenate, pentaerythritol diacetate dibehenate, glycerin tribehenate, and 1,18-octadecanediol distearate. Examples of the polyalkanol ester include tristearyl trimellitate, and distearyl maleate. Examples of the polyalkanoic acid amide include dibehenyl amide. Examples of the polyalkyl amide include trimellitic acid tristearyl amide. Examples of the dialkyl ketone include distearyl ketone. Among the carbonyl group-containing wax mentioned above, polyalkanoic acid ester is particularly preferable.

Examples of the polyolefin wax include polyethylene wax, and polypropylene wax.

Examples of the long-chain hydrocarbon include paraffin wax, and Sasol wax.

The melting point of the release agent is appropriately selected depending on the intended purpose without any limitation, but it is preferably from 40 to 160° C., more preferably from 50 to 120° C., and even more preferably from 60 to 90° C. When the melting point thereof is lower than 40° C., use of such release agent may adversely affect the heat resistance storage stability of the resulting toner. When the melting point thereof is higher than 160° C., the resulting toner is likely to cause cold offset during the fixing at low temperature.

The melting point of the release agent can be measured, for example, by means of a differential scanning calorimeter (DSC210, Seiko Instruments Inc.) in the following manner. A sample of the release agent is heated to 200° C., cooled from 200° C. to 0° C. at the cooling rate of 10° C./min., followed by heating at the heating rate of 10° C./min. The maximum peak temperature of heat of melting as obtained is determined as a melting point of the release agent.

A melt viscosity of the release agent, which is measured at the temperature higher than the melting point of the release agent by 20° C., is preferably from 5 to 1,000 cps, more preferably from 10 to 100 cps. When the melt viscosity thereof is lower than 5 cps, the releasing ability of the toner may be degraded. When the melt viscosity thereof is higher than 1,000 cps, the effect of improving hot offset resistance and low-temperature fixability may not be attained.

An amount of the releasing agent in the toner is appropriately selected depending on the intended purpose without any limitation, but it is preferably from 0 to 40% by weight, more preferably from 3 to 30% by weight. When the amount of the releasing agent is greater than 40% by weight, the flowability of the toner particles may be degraded.

### <<Charge Controlling Agent>>

The charge controlling agent is appropriately selected from those known in the art without any limitation, but it is preferably a no-color or white material as use of a colored material as the charge controlling agent may change a color tone of the toner. Examples of such charge controlling agent include a triphenyl methane dye, a molybdic acid chelate compound, Rhodamine dye, alkoxy amine, a quaternary ammonium salt (including a fluorine-modified quaternary ammonium salt), alkylamide, phosphor and a compound including phosphor, tungsten and a compound including tungsten, a fluorine-containing activator, a metal salt of salicylic acid, and a metal salt of salicylic acid derivative. These may be used alone, or in combination.

The charge controlling agent may be selected from commercial products thereof, and examples of the commercial products include: BONTRON P-51 (quaternary ammonium salt), E-82 (oxynaphthoic acid-based metal complex), E-84 (salicylic acid-based metal complex) and E-89 (phenol condensate), all from ORIENT CHEMICAL INDUSTRIES CO., LTD; TP-302 and TP-415 (quaternary ammonium salt molybdenum complexes) both from Hodogaya Chemical Co., Ltd.; COPY CHARGE PSY VP 2038 (quaternary ammonium salt), COPY BLUE PR (triphenylmethane derivative), COPY CHARGE NEG VP2036 and COPY CHARGE NX VP434 (quaternary ammonium salts), all from Hoechst AG; LRA-901 and LR-147 (boron complexes), both from Japan Carlit Co., Ltd.; quinacridone; azo pigments; and polymeric compounds having, as a functional group, a sulfonic acid group, carboxyl group, quaternary ammonium salt, etc.

An amount of the charge controlling agent in the toner cannot be determined unconditionally, as it varies depending on the binder resin for use, the presence of the additive, the dispersion method, etc. For example, an amount of the charge controlling agent is preferably from 0.1 to 10 parts by weight, more preferably from 0.2 to 5 parts by weight, relative to 100 parts by weight of the binder resin. When the amount thereof is smaller than 0.1 parts by weight, the charge controlling ability cannot be attained. When the amount thereof is greater than 10 parts by weight the electrostatic propensity of the resulting toner is excessively large, which reduces the effect of charge controlling agent. As a result, the electrostatic suction force toward the developing roller may increase, which may cause poor flowing ability of the developer, and low image density.

The charge controlling agent may be dissolved and dispersed after being melted and kneaded together with the master batch, or added together with other components of the toner directly to an organic solvent when dissolution and/or dispersion is performed. Alternatively, the charge controlling agents may be fixed on surfaces of toner particles after the production of the toner particles.

### 2) Aqueous Medium—

As for the aqueous medium, water may be used solely, or water may be used in combination with water-miscible solvent. Examples of the water-miscible solvent include alcohol (e.g., methanol, isopropanol, and ethylene glycol), dimethyl formamide, tetrahydrofuran, cellosolves (e.g., methyl cellosolve), and lower ketones (e.g., acetone, and methyl ethyl ketone).

An amount of the aqueous medium used to 100 parts by weight of the toner composition is appropriately selected depending on the intended purpose without any limitation, but it is typically from 50 to 2,000 parts by weight, preferably from 100 to 1,000 parts by weight. When the amount of the water-miscible solvent is smaller than 50 parts by weight, the toner composition cannot be desirably dispersed, which enables to provide toner particles having the predetermined particle diameters. When the amount thereof is greater than 2,000 parts by weight, it is not economical.

A surfactant, a polymer protective colloid, an inorganic dispersant and/or organic resin particles may be dispersed in the aqueous medium in advance, which is preferable for giving a sharp particle distribution to the resulting toner, and giving dispersion stability.

### <Surfactant>

The surfactant is appropriately selected depending on the intended purpose without any limitation, and examples thereof include: anionic surfactants such as alkyl benzene sulfonic acid salts, α-olefin sulfonic acid salts and phosphoric acid esters; cationic surfactants, such as amine salts (e.g., alkyl amine salts, amino alcohol fatty acid derivatives, polyamine fatty acid derivatives and imidazoline), and quaternary ammonium salt (e.g., alkyltrimethylammonium salts, dialkyldimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Examples of the fluoroalkyl group-containing surfactant include a fluoroalkyl group-containing anionic surfactant, and a fluoroalkyl group-containing cationic surfactant.

Examples of the fluoroalkyl group-containing anionic surfactant include C2-C10 fluoroalkyl carboxylic acid or a metal salt thereof, disodium perfluorooctane sulfonyl glutamate, sodium 3-[ω-fluoroalkyl(C6-C11)oxy)-1-alkyl(C3-C4) sulfonate, sodium 3-[ω-fluoroalkanoyl(C6-C8)-N-ethylamino]-1-propanesulfonate, fluoroalkyl(C11-C20) carboxylic acid or a metal salt thereof, perfluoroalkylcarboxylic acid(C7-C 13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salt, a salt of perfluoroalkyl(C6-C10)-N-ethylsulfonylglycin and monoperfluoroalkyl(C6-C16) ethylphosphate.

Examples of the fluoroalkyl group-containing cationic surfactant include a fluoroalkyl group-containing aliphatic primary or secondary amine acid, aliphatic quaternary ammonium salt such as a perfluoroalkyl(C6 to C10)sulfonic amide propyltrimethyl ammonium salt, benzalkonium salt, benzetonium chloride, pyridinium salt and imidazolinium salt.

### <Polymer Protective Colloid>

The polymer protective colloid is appropriately selected depending on the intended purpose without any limitation, and examples thereof include: acids such as acids such as acrylic acid, methacrylic acid, α-cyanoacrylic acid, α-cyanomethacrylic acid, itaconic acid, crotonic acid, fumaric acid, maleic acid and maleic anhydride; (meth)acryl monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acryl amide, and N-methylol methacryl amide; vinyl alcohol or ethers with vinyl alcohol, such as vinyl methyl ether, vinyl ethyl ether, and vinyl propyl ether; ester of vinyl alcohol and a compound containing a carboxyl group, such as vinyl acetate, vinyl propionate, and vinyl butyrate; acryl amide, methacryl amide, diacetone acryl amide or methylol compounds of the preceding amides; acid chlorides, such as acrylic acid chloride, and methacrylic acid chloride; a homopolymer or copolymer containing a nitrogen atom or its heterocycle, such as vinyl pyridine, vinyl pyrrolidone, vinyl imidazole, and ethylene imine; polyoxyethylenes, such as polyoxy ethylene, polyoxypropylene, polyoxy ethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and celluloses such as methyl cellulose, hydroxyethyl cellulose, and hydroxypropyl cellulose.

### <Inorganic Dispersant>

Examples of the inorganic dispersant include tricalcium phosphate, calcium carbonate, titanium oxide, colloidal silica and hydroxyapatite.

### <Organic Resin Particles>

As for the resin for forming the organic resin particles, any resin can be used as long as it is a resin capable of forming an aqueous dispersant, and the resin for forming the organic resin particles may be a thermoplastic resin or thermoset resin. Examples of the resin for forming the organic resin particles include a vinyl resin, a polyurethane resin, an epoxy resin, a polyester resin, a polyamide resin, a polyimide resin, a silicon resin, a phenol resin, a melamine resin, a urea resin, an aniline resin, an ionomer resin, and a polycarbonate resin. These may be used alone, or in combination. Among them, a vinyl resin, a polyurethane resin, an epoxy resin, a polyester resin, and a combination of any of the preceding resins are preferable because an aqueous dispersion liquid of fine spherical resin particles can be easily obtained.

### 3) Emulsification or Dispersion

Amounts of the oil phase and the aqueous medium in emulsification or dispersion is appropriately selected depending on the intended purpose without any limitation, the amount of the oil phase is preferably from 10 to 90% by weight and the amount of the aqueous medium is preferably from 90 to 10% by weight. In this range an emulsion or a suspension in which the oil phase is dispersed in the aqueous medium is formed.

The method for emulsifying and/or dispersing in the aqueous medium is not particularly limited, and to which a conventional equipment, such as a low-speed shearing disperser, a high-speed shearing disperser, a friction disperser, a high-pressure jetting disperser and ultrasonic wave disperser, can be employed. Among them, the high-speed shearing disperser is preferable in view of miniaturizing size of particles. In use of the high-speed shearing disperser, the rotating speed is appropriately selected without any limitation, but it is typically 1,000 rpm to 30,000 rpm, preferably 5,000 rpm to 20,000 rpm. The temperature for dispersing is typically 0° C. to 150° C. (in a pressurized state), preferably 20° C. to 80° C.

In the case where the toner composition contains the binder resin precursor, the compound containing an active hydrogen group, which is necessary for an elongation and/or crosslink reaction of the binder resin precursor, may be mixed in an oil phase before dispersing the toner composition in an aqueous medium, or mixed in the aqueous medium.

### 4) Emulsified Particles

The emulsified particles are formed by emulsifying or dispersing the oil phase in the aqueous medium.

The emulsified particles have the same composition as that of the oil phase. Namely, the emulsified particles are formed by dissolving or dispersing toner materials including at least one of the binder resin and the binder resin precursor and a colorant, and other components such as an organic-modified layered inorganic mineral, a release agent, a charge controlling agent and a compound including an active hydrogen group reactable with the binder resin precursor when necessary in an organic solvent.

### [Process of Convergence to Granulate Mother Toner Particles]

In a process of converging the emulsified particles to granulate mother toner particles, a temperature of the emulsified dispersion is controlled to control an average circularity of the mother toner particles. Since the resin component included in the oil phase includes the crystalline resin in an amount not less than 50% by weight, when the liquid temperature is lowered to have a temperature less than a melting point of the crystalline resin, the crystalline resin begins to crystallize even in the oil phase. The temperature of the emulsified dispersion is controlled to control the crystallization, and an association state of the mother toner particles are changed as desired to control the circularity thereof.

### 1) Convergence

The convergence is performed by associating the emulsified particles present adjacent to each other, which are formed by emulsifying or dispersing the oil phase in the aqueous medium. The convergence forms a particle from the emulsified particles present adjacent to each other.

When the oil phase is emulsified or dispersed in the aqueous medium, a high shearing force is applied at a temperature not less than a melting point of the crystalline resin to form spherical emulsified particles in accordance with a difference in an interface tension between the oil phase and the aqueous medium.

Then, a low shearing force like slow stirring is applied to the oil phase or the convergence is performed in a resting state to form a toner having a narrow particle diameter distribution. Its is thought this is because a small oil drop is associated with a large oil drop to decrease a fine powder area even when the oil phase has a wide particle diameter distribution, and the total particle diameter distribution becomes narrow.

### 2) Control of Circularity of Mother Toner Particles

In order to control the shape of a toner, when the emulsified particles right after emulsified or dispersed are converged to granulate mother particles, the temperature is controlled to form agglomerated particles not united particles to control the circularity. The “unit” means a state in which associated particles form a body each other to have no border, and “agglomeration” means a state in which associated particles are adsorbed with each other while keeping interfaces therebetween. When the emulsified particles have a temperature not less than 5° C. which is a melting point of the crystalline resin, the emulsified particles are united with each other to be spheronized. However, when less than the melting point, the emulsified particles are crystallized and have higher viscosity, resulting in agglomerated particles keeping interfaces. The emulsified particles preferably have a temperature of from 0 to 40° C., and more preferably from 10 to 30° C. to form agglomerated particles, although depending on the melting point and dispersing conditions of the crystalline resin. When less than 0° C., it is possible that the agglomeration balance largely changes in a system of the aqueous medium and the emulsified particles. When higher than 40° C., it is possible that the crystalline resin is not crystallized.

Further, the temperature of the agglomerated particles may be increased to gradually lighten up the crystallization of the crystalline resin to unite a part of the agglomerated particles. The temperature is adjusted to control the associated particles to be in a state between agglomeration and unit to control the circularity. The associated particles preferably have a temperature of from 10 to 40° C. to unite a part of the agglomerated particles, although depending on the melting point and dispersing conditions of the crystalline resin. When less than 10° C., it is possible that the crystallization is not sufficiently lightened up. When higher than 40° C., it is possible that the crystallization is too lightened up. The circularity is a value determined by dividing a circumferential length of an equivalent circle having a projected area equal to the shape of the associated particle with a circumferential length of the actual particle, and preferably from 0.940 to 0.980, and more preferably from 0.950 to 0.970. The number of the particles having an average circularity not less than 0.970 is preferably 10% or less based on total number thereof. When greater than 0.980, in an image forming system using a blade cleaning, a photoreceptor or a transfer belt is poorly cleaned, an image is contaminated, e.g., particularly when an image having a high image area ratio such as a photo image is formed, an untransferred toner on a photoreceptor occasionally causes background fouling or contaminates a charging roller charging the photoreceptor while contacting thereto, resulting in occasional deterioration of chargeability. The average circularity is measured by an optical detection zone method passing a suspension liquid including a toner through a plate-shaped imaging detection zone to optically detect a particle image with a CCD camera and analyze the image, e.g., with a flow particle image analyzer FPIA-2100 from Sysmex Corp.

The associated particles have innumerable surface concavities and convexities because each particle interface is lost in the process in which the agglomerated particles are partly united.

### [Process of Removing Organic Solvent]

In a process of removing the organic solvent, the organic solvent is removed from mother toner particles formed by converging after emulsifying or dispersing an oil phase including the organic solvent.

Methods of removing the organic solvent include a method of spraying the emulsified dispersion in a dry atmosphere and completely removing non-hydrosoluble organic solvent in an oil drop to form mother toner particles, and evaporating an aqueous dispersant to be removed as well.

### [Other Processes]

After the organic solvent is removed, the mother toner particles are washed, dried, and further classified when desired. The classifying can be performed by removing the fine particles component in a liquid by means of a cyclone, a decanter, a centrifugal separator, or the like.

The mother toner particles are subjected to a dry process of an external additive when necessary to prepare a toner. The dry process of an external additive is performed by known methods using mixers, etc. The mother toner particles are mixed with other particles such as a fluidity improver, a cleanability improver and a magnetic material to form a mixed powder and a mechanical impact is applied thereto to for immobilization or fusion of other particles on the toner surface, to thereby prevent the other particles from dropping off from the surfaces of the toner particles.

Specific examples of the method include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate. Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

### <External Additive>

The external additive is appropriately selected from those known in the art depending on the intended purpose without any restriction, and examples thereof include silica particles, hydrophobic silica particles, a fatty acid metal salt (e.g., zinc stearate, and aluminum stearate), metal oxide (e.g., titanium oxide, alumina, tin oxide, and antimony oxide), hydrophobic metal oxide particles, and fluoropolymer. Among them, hydrophobic silica particles, hydrophobic titanium oxide particles, and hydrophobic alumina particles are preferable.

Examples of the silica particles include: HDK H 2000, HDK H 2000/4, HDK H 2050EP, HVK21, and HDK H1303 (all from Hoechst AG); and R972, R974, RX200, RY200, R202, R805, and R812 (all from Nippon Aerosil Co., Ltd.). Examples of the titanium oxide particles include: P-25 (from Nippon Aerosil Co., Ltd.); STT-30, and STT-65C-S (both from Titan Kogyo, Ltd.); TAF-140 (from Fuji Titanium Industry Co., Ltd.); and MT-150W, MT-500B, MT-600B, and MT-150A (all from TAYCA CORPORATION). Examples of the hydrophobic titanium oxide particles include: T-805 (from Nippon Aerosil Co., Ltd.); STT-30A, and STT-65S-S (both from Titan Kogyo, Ltd.); TAF-500T, and TAF-1500T (both from Fuji Titanium Industry Co., Ltd.); MT-100S, and MT-100T (both from TAYCA CORPORATION); and IT-S (from ISHIHARA SANGYO KAISHA, LTD.).

In order to attain hydrophobic silica particles, hydrophobic titanium oxide particles, and hydrophobic alumina particles, hydrophilic particles (e.g., silica particles, titanium oxide particles, and alumina particles) are treated with a silane coupling agent such as methyltrimethoxy silane, methyltriethoxy silane, and octyltrimethoxy silane.

As for the external additive, silicone-oil-treated inorganic particles, which have been treated with silicone oil, optionally with an application of heat, can be suitably used.

As for the silicone oil, for example, dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, acryl or methacryl-modified silicone oil, and α-methylstyrene-modified silicone oil can be used.

Examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. Among them, silica, and titanium dioxide are particularly preferable.

An amount of the external additive for use is preferably from 0.1 to 5% by weight, more preferably from 0.3 to 3% by weight, relative to the toner.

The number average particle diameter of primary particles of the inorganic particles is preferably 100 nm or smaller, more preferably from 3 to 70 nm. When the number average particle diameter thereof is smaller than 3 nm, the inorganic particles are embedded into the toner particles, and therefore the inorganic particles do not effectively function. When the number average particle diameter is greater than 100 nm, the inorganic particles may unevenly damage a surface of an electrostatic latent image bearer, and hence not preferable.

As the external additive, the inorganic particles, hydrophobic inorganic particles and the like may be used in combination. The number average particle diameter of primary particles of hydrophobic particles is preferably from 1 to 100 nm. Of these, it is preferred that the external additive contain two types of inorganic particles having the number average particle diameter of from 5 to 70 nm. Further, it is preferred that the external additive contain two types of inorganic particles having the number average particle of hydrophobic-treated primary particles thereof being 20 nm or smaller, and one type of inorganic particles having the number average particle thereof of 30 nm or greater. Moreover, the external additive preferably has BET specific surface area of from 20 to 500 m²/g.

Examples of the surface treatment agent for the external additive containing the oxide particles include: a silane-coupling agent (e.g., dialkyl dihalogenated silane, trialkyl halogenated silane, alkyl trihalogenated silane, and hexaalkyl disilazane), a sililation agent, a silane-coupling agent containing a fluoroalkyl group, an organic titanate-based coupling agent, an aluminum-based coupling agent, silicone oil, and silicone varnish.

As the external additive, resin particles can also be added. Examples of the resin particles include; polystyrene obtained by a soap-free emulsification polymerization, suspension polymerization, or dispersion polymerization; copolymer of methacrylic ester or acrylic ester; polymer particles obtained by polymerization condensation, such as silicone, benzoguanamine, and nylon; and polymer particles formed of a thermoset resin. Use of these resin particles in combination can reinforce the charging ability of the toner, reduces reverse charges of the toner, reducing background deposition. An amount of the resin particles for use is preferably from 0.01 to 5% by weight, more preferably from 0.1 to 2% by weight, relative to the toner.

### <Fluidity Improver>

The fluidity improver is an agent capable of performing surface treatment of the toner to increase hydrophobicity, and preventing degradations of flow properties and charging properties of the toner even in a high humidity environment. Examples of the fluidity improver include a silane-coupling agent, a sililation agent, a silane-coupling agent containing a fluoroalkyl group, an organic titanate-based coupling agent, an aluminum-based coupling agent, silicone oil, and modified silicone oil.

### <Cleanability Improver>

The cleanability improver is added to the toner for the purpose of removing the developer remained on an electrostatic latent image bearer or intermediate transfer member after transferring. Examples of the cleanability improver include: fatty acid metal salt such as zinc stearate, calcium stearate, and stearic acid; and polymer particles produced by soap-free emulsification polymerization, such as polymethyl methacrylate particles, and polystyrene particles. The polymer particles are preferably those having a relatively narrow particle size distribution, and the polymer particles having the weight-average particle diameter of from 0.01 to 1 μm are preferably used.

### <Magnetic Material>

The magnetic material is appropriately selected from those known in the art depending on the intended purpose without any limitation, and examples thereof include iron Powder, magnetite, and ferrite. Among them, a white magnetic material is preferable in view of color tone.

### [Properties of Toner]

In order to achieve both low-temperature fixability and heat resistance storage stability of highly desirable level, and to achieve excellent hot offset resistance of the toner of the present invention, the toner satisfies: 45≦Ta≦70, and 0.8≦Tb/Ta≦1.55, where Ta (° C.) is the maximum peak temperature of heat of melting the toner measured by a differential scanning calorimeter, and Tb (° C.) is a softening point of the toner measured by an elevated flow tester. In addition, the toner preferably satisfies: 1.0×10³≦G′(Ta+20)≦5.0×10⁶, and 1.0×10³≦G″(Ta+20)≦5.0×10⁶, where G′(Ta+20) (Pa·s) is the storage elastic modulus of the toner at the temperature of (Ta+20)° C., and G″(Ta+20) (Pa·s) is the loss elastic modulus of the toner at the temperature of (Ta+20)° C.

The maximum peak temperature (Ta) of heat of melting the toner is appropriately selected depending on the intended purpose without any limitation, but it is preferably from 45 to 70° C., more preferably from 53 to 65° C., and even more preferably from 58 to 62° C. When Ta is from 45 to 70° C., the minimum heat resistance storage stability required for the toner can be secured, and the toner having low-temperature fixability more excellent than that of the conventional toner can be attained. When Ta is lower than 45° C., the desirable low-temperature fixability of the toner can be attained, but the heat resistance storage stability is insufficient. When Ta is higher than 70° C., the heat resistance storage stability is improved, but the low-temperature fixability reduces.

The ratio (Tb/Ta) of the softening temperature (Tb) of the toner to the maximum peak temperature (Ta) of heat of melting the toner is appropriately selected depending on the intended purpose without any limitation, but it is preferably from 0.8 to 1.55, more preferably from 0.85 to 1.25, even more preferably from 0.9 to 1.2, and particularly preferably from 0.9 to 1.19. The toner has a property that the resin sharply softens as the value of Tb reduces, which is excellent in terms of both low-temperature fixability and heat resistance storage stability.

As for the viscoelasticity of the toner, the storage elastic modulus G′(Ta+20) at the temperature of (Ta+20)° C. is preferably from 1.0×10³ to 5.0×10⁶ Pa·s in view of fixing strength and hot offset resistance, and more preferably from 1.0×10⁴ to 5.0×10⁵ Pa·s. Moreover, the loss elastic modulus G″(Ta+20) at the temperature of (Ta+20)° C. is preferably from 1.0×10³ to 5.0×10⁶ Pa·s in view of hot offset resistance, and more preferably from 1.0×10⁴ to 5.0×10⁵ Pa·s.

Further, the toner preferably satisfies: 0.05≦[G″(Ta+30)/G″(Ta+70)]≦50, where G″(Ta+30)(Pa·s) is the loss elastic modulus of the toner at the temperature of (Ta+30)° C., and G″(Ta+70) (Pa·s) is the loss elastic modulus at the temperature of (Ta+70)° C. By designing the toner to fall into the aforementioned range, the change in the loss elastic modulus of the toner against the temperature becomes mild, so that the resulting toner has excellent hot offset resistance with maintaining low-temperature fixability. The value of [G″(Ta+30)/G″(Ta+70)] is preferably from 0.05 to 50, more preferably from 0.1 to 40, and even more preferably from 0.5 to 30.

The viscoelasticity of the toner can be appropriately controlled by adjusting a mixing ratio of the crystalline resin and non-crystalline resin constituting the binder resin, molecular weight of each resin, or formulation of the monomer mixture.

### [Developer]

The developer of the present invention contains the toner, and may further contain appropriately selected other components, such as carrier, if necessary.

The developer may be a one-component developer, or two-component developer, but is preferably a two-component developer for use in recent high-speed printers corresponded to the improved information processing speed, in view of a long service life.

In the case of the one-component developer using the toner, the diameters of the toner particles do not vary largely even when the toner is balanced, namely, the toner is supplied to the developer, and consumed by developing, the toner does not cause filming to a developing roller, nor fuse to a layer thickness regulating member such as a blade for thinning a thickness of a layer of the toner, and provides excellent and stable developing ability and image even when it is used (stirred)) in the image developer over a long period of time.

In the case of the two-component developer using the toner, the diameters of the toner particles in the developer do not vary largely even when the toner is balanced, and the toner can provide excellent and stabile developing ability even when the toner is stirred in the image developer over a long period of time.

### <Carrier>

The carrier is appropriately selected depending on the intended purpose without any limitation, but the carrier is preferably a carrier containing core particles, and a resin layer covering each core particle.

A material for the core particles is appropriately selected from those known in the art without any limitation, but it is preferably from 50 to 90 emu/g manganese-strontium (Mn—Sr) material, or manganese-magnesium (Mn—Mg) material, and preferably a hard magnetic material such as iron powder (100 emu/g or higher), and magnetite (from 75 to 120 emu/g) is preferable for securing sufficient image density. Moreover, the material is preferably a soft magnetic material such as a copper-zinc (Cu—Zn) (from 30 to 80 emu/g) material because the toner particles born in the form of brush reduces an impact by contact to an electrostatic latent image bearer, which is advantageous for providing high image quality. These may be used alone, or in combination.

As for particle diameters of the core particles, the average particle diameter (weight-average particle diameter D50) of the core particles is preferably from 10 to 200 μm, more preferably from 40 to 100 When the average particle diameter (weight-average particle diameter (D50)) is smaller than 10 μm, the proportion of fine particles in the distribution of carrier particle diameters increases, increasing fine particles, causing carrier scattering because of low magnetization per carrier particle. When the average particle diameter thereof is greater than 200 μm, the specific surface area reduces, which may cause toner scattering, causing reproducibility especially in a solid image portion in a full color printing containing many solid image portions.

A material of the resin layer is appropriately selected from resins known in the art depending on the intended purpose without any limitation, and examples thereof include an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, copolymer of vinylidene fluoride and acryl monomer, vinylidene fluoride-vinyl fluoride copolymer, fluoroterpolymer (e.g., terpolymer of tetrafluoroethylene, vinylidene fluoride, and non-fluoromonomer), and a silicone resin. These may be used alone, or in combination. Among them, a silicone resin is particularly preferable.

The silicone resin is appropriately selected from silicone resins commonly known in the art depending on the intended purpose without any limitation, and examples thereof include a straight silicone resin constituted of organosiloxane bonds; and a modified silicone resin, which is modified with an alkyd resin, a polyester resin, an epoxy resin, an acryl resin, or a urethane resin.

The silicone resin can be selected from commercial products. Examples of commercial products of the straight silicone resin include: KR271, KR255, and KR152 from Shin-Etsu Chemical Co., Ltd.; and SR2400, SR2406, and SR2410 from Dow Corning Toray Co., Ltd.

As for the modified silicone resin, commercial products thereof can be used. Examples of the commercial products thereof include: KR206 (alkyd-modified), KR5208 (acryl-modified), ES1001N (epoxy-modified), and KR305 (urethane-modified) from Shin-Etsu Chemical Co., Ltd.; and SR2115 (epoxy-modified), SR2110 (alkyd-modified) from Dow Corning Toray Co., Ltd.

Note that, the silicone resin can be used along, but the silicone resin can also be used together with a component capable of performing a crosslink reaction, a component for adjusting charging value, or the like.

The resin layer optionally contains electric conductive powder, and examples thereof include metal powder, carbon black, titanium oxide, tin oxide, and zinc oxide. The average particle diameter of the electric conductive powder is preferably 1 μm or smaller. When the average particle diameter thereof is greater than 1 μm, it may be difficult to control electric resistance.

The resin layer can be formed, for example, by dissolving the silicone oil or the like in a solvent to prepare a coating solution, uniformly applying the coating solution to surfaces of core particles by a conventional coating method, and drying the coated solution, followed by baking. Examples of the coating method include dip coating, spray coating, and brush coating.

The solvent is appropriately selected depending on the intended purpose without any limitation, and examples thereof include toluene, xylene, methyl ethyl ketone, methyl isobutyl ketone, cellosolve, and butyl acetate.

Baking may employ an external heating system or an internal heating system, without any limitation. Examples thereof include a method using a fix electric furnace, a flow electric furnace, a rotary electric furnace, or a burner furnace, and a method using microwaves.

An amount of the resin layer in the carrier is preferably from 0.01 to 5.0% by weight. When the amount thereof is smaller than 0.01% by weight, a uniform resin layer may not be formed on a surface of a core material. When the amount thereof is greater than 5.0% by weight, a thickness of the resin layer becomes excessively thick so that a plurality of carrier particles may form into one particle, and therefore uniform carrier particles cannot be obtained.

In the case where the developer is a two-component developer, an amount of the carrier in the two-component developer is appropriately selected depending on the intended purpose without any limitation, and it is, for example, preferably from 90 to 98% by weight, more preferably from 93 to 97% by weight.

A mixing ratio between the toner and the carrier in the two-component developer is typically from 1 to 10.0 parts by weight of the toner relative to 100 parts by weight of the carrier.

### [Image Forming Apparatus]

The image forming apparatus of the present invention contains at least an electrostatic latent image bearer, a charger, an irradiator, an image developer, a transferer, and a fixer, and may further contain appropriately selected other units, such as a cleaner, a discharger, a recycler, and a controller, if necessary.

The image developer is a unit configured to develop an electrostatic latent image with a toner to form a visible image, where the toner is the toner of the present invention.

Note that, the charger and the irradiator may be collectively referred to as an electrostatic latent image forming unit. The image developer contains a magnetic field generating unit fixed inside thereof, and contains a developer bearer capable of bearing the toner of the present invention and rotating.

### <Electrostatic Latent Image Bearer>

The material, shape, structure, size, of the like of the electrostatic latent image bearer is appropriately selected depending on the intended purpose without any limitation. Examples of the shape thereof include a drum shape, a sheet shape, and an endless belt shape. As for the structure thereof, the electrostatic latent image bearer may have a single layer structure or a multilayer structure. The size thereof can be appropriately selected depending on the size and specification of the image forming apparatus. Examples of the material thereof include: an inorganic photoreceptor such as amorphous silicon, selenium, CdS, and ZnO; and an organic photoreceptor (OPC) such as polysilane, and phthalopolymethine.

### <Charger>

The charger is a unit configured to charge a surface of the electrostatic latent image bearer.

The charger is appropriately selected depending on the intended purpose without any limitation, provided that it is capable of applying voltage to and uniformly charging a surface of the electrostatic latent image bearer. The charge unit is roughly classified into a (1) contact charger which charges by being in contact with electrostatic latent image bearer, and a (2) non-contact charger which charges without being in contact with the electrostatic latent image bearer.

Examples of the (1) contact charger include an electric conductive or semiconductive charging roller, a magnetic brush, a fur brush, a film, and a rubber blade. Among them, the charging roller enables to significantly reduce a generating amount of ozone compared to corona discharge, has excellent stability when the electrostatic latent image bearer is used repeatedly, and is effective in prevention of image deterioration.

Examples of the (2) non-contact charger include: a non-contact charger or needle electrode device utilizing corona discharge, and a solid discharge element; and an electric conductive or semiconductive charging roller provided with only a slight space to the electrostatic latent image bearer.

### <Irradiator>

The irradiator is a unit configured to expose the charged surface of the electrostatic latent image bearer to light to form an electrostatic latent image.

The irradiator is appropriately selected depending on the intended purpose without any limitation, provided that it is capable of exposing the surface of the electrostatic latent image bearer, which has been charged by the charger, to imagewise light corresponding to an image to be formed. Examples of the irradiator include various exposure devices, such as a reproduction optical exposure device, a rod-lens array exposure device, a laser optical exposure device, a liquid crystal shutter optical device, and an LED optical exposure device. Moreover, the image developer may employ a back light system in which imagewise light is applied from the back side of the electrostatic latent image bearer for exposing.

<Image developer>

The image developer is a unit configured to develop the electrostatic latent image with a toner, where the toner is the toner of the present invention.

The image developer is appropriately selected from those known in the art without any limitation, provided that it can develop using the toner. As for the image developer, for example, a unit containing at least an image developer housing the toner therein and capable of applying the toner to the electrostatic latent image in a contact or non-contact manner is preferable.

The image developer may employ a dry developing system, or a wet developing system. The image developer may be an image developer for a single color, or an image developer for multicolor. Preferable examples thereof include a developing device containing a stirrer for rubbing and stirring the toner to charge the toner, a magnetic field generating unit fixed inside the device, and a rotatable developer bearer bearing a developer containing the toner on the surface thereof.

In the image developer, for example, the toner and the carrier are mixed and stirred, by the friction of which the toner is charged. The charged toner is held on a surface of a rotatable magnet roller in the form of a brush to form a magnet brush. Since the magnet roller is located adjacent the electrostatic latent image bearer, part of the toner constituting the magnet brush formed on the surface of the magnet roller is moved to the surface of the electrostatic latent image bearer by electric suction force. As a result, the electrostatic latent image is developed with the toner to form a visible image on the surface of the electrostatic latent image bearer.

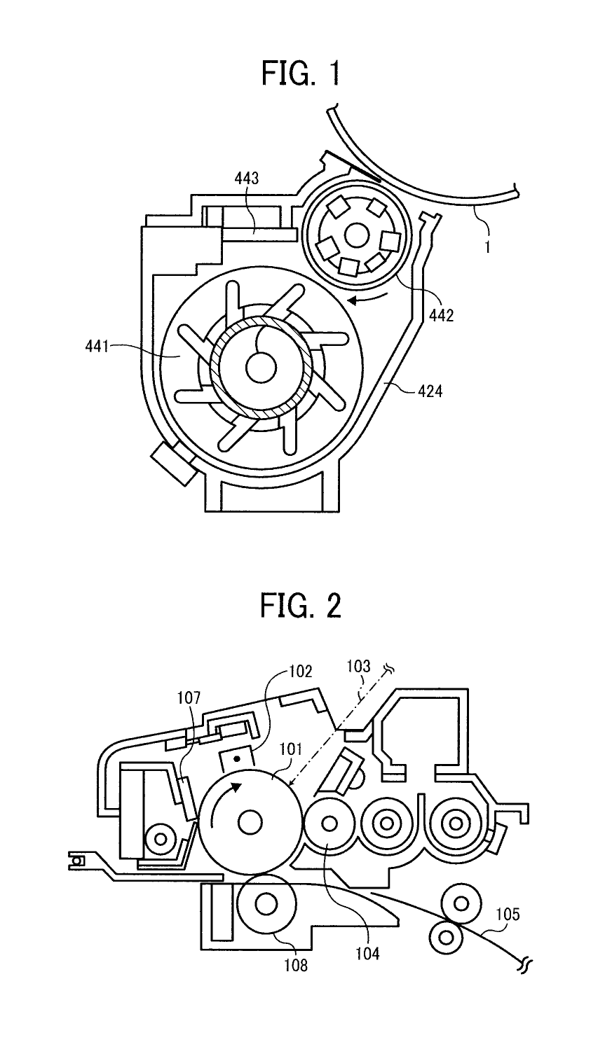

FIG. 1 is a schematic view illustrating an embodiment a two-component image developer using a two-component developer formed with a toner and a magnetic carrier. In the two-component developing device illustrated in FIG. 1, the two-component developer is stirred and conveyed by a screw 441, and then supplied to a developing sleeve 442 serving as a developer bearer. The two-component developer supplied to the developing sleeve 442 is regulated by a doctor blade 443 serving as a layer thickness regulating member, and the amount of the developer to be supplied is controlled by a doctor gap, which is a space between the doctor blade 443 and the developer sleeve 442. When the doctor gap is too narrow, the amount of the developer is insufficient, causing insufficient in image density. When the doctor gap is too wide, conversely, an excessive amount of the developer is supplied to thereby cause a problem that the carrier deposition occurs on the photoreceptor drum 1 serving as the electrostatic latent image bearer. Accordingly, a magnet is provided inside the developing sleeve 442 as a magnetic field generating unit configured to form a magnetic field so that the developer forms brush around the circumferential surface of the magnetic sleeve. The developer forms a magnetic brush raised in the form of chains on the developer sleeve 442 along with the magnetic line of force in the direction of normal line emitted from the magnet.

The developer sleeve 442 and the photoreceptor drum 1 are provided so as to be adjacent each other with a certain gap (i.e. developing gap), and a developing region is formed at the area where the both facing each other. The developing sleeve 442 is formed by forming a non-magnetic material (e.g. aluminum, brass, stainless steel, and an electric conductive resin) into a cylinder, and is driven to rotate by a rotation driving unit (not illustrated). The magnetic brush is transported to the developing region by the rotation of the developing sleeve 442. To the developing sleeve 442, developing voltage is applied from a power source for developing (not illustrated), and the toner on the magnetic brush is separated from the carrier by the developing electric field formed between the developing sleeve 442 and the photoreceptor drum 1 serving as the electrostatic latent image bearer, to develop the electrostatic latent image on the photoreceptor drum 1. Note that, alternating current may be overlapped for the developing voltage.

The developing gap is preferably from about 5 to 30 times the particle diameter of the developer. In the case where the particle diameter of the developer is 50 μm, the developing gap is preferably set to the range of from 0.25 to 1.5 mm. When the developing gap is larger than the aforementioned range, desirable image density may not be attained.

The doctor gap is preferably the same to or slightly larger than the developing gap. The diameter and linear velocity of the photoreceptor drum 1, and the diameter and linear velocity of the developing sleeve 442 are determined within restrictions such as the copying speed, or the size of the device. A ratio of the linear velocity of the drum to the linear velocity of the sleeve is preferably 1.1 or greater to attain sufficient image density. Note that, process conditions may be controlled by providing a sensor in a position downstream of the developing region, and detecting the deposition amount of the toner from the optical reflectance.

### <Transferer>

The transferer is a unit configured to transfer the visible image onto a recording medium.

The transferer is roughly classified into a transferer which directly transfer the visible image on the electrostatic latent image bearer to a recording medium, and a secondary transferer, which uses an intermediate transfer member, and after primary transferring the visible image to the intermediate transfer member, secondary transfer the visible image to a recording medium. Whichever it is, the transferer is appropriately selected from transferring members known in the art depending on the intended purpose without any limitation.

### <Fixer>

The fixer is a unit configured to fix the transferred image on the recording medium.

The fixer is appropriately selected depending on the intended purpose without any limitation. As for the fixer, a fixing device containing a fixing member and a heater for heating the fixing member is preferably used. The fixing member is appropriately selected depending on the intended purpose without any limitation, provided that it can form a nip in contact with another fixing member. Examples thereof include a combination of an endless belt and a roller, and a combination of a roller and a roller. Considering the reduced warm-up time, and energy saving, use of a combination of an endless belt and a roller, or use of a heating method where the fixing member is heated from its surface by induction heating is preferable.

The fixer is roughly classified into a (1) embodiment (internal heating system) where a fixer containing at least any of a roller or a belt, which is heated from the surface that is not in contact with the toner, and the transferred image on the recording medium is heated and pressurized to fix, and a (2) embodiment (external heating system) where a fixer contains at least any of a roller or a belt, which is heated from the surface that is in contact with the toner, and the transferred image on the recording medium is heated and pressurized to fix. Note that, it is possible to employ both of them in combination.

Examples of the (1) fixer of the internal heating system include a fixer containing a fixing member, where the fixing member contains a heating unit inside thereof. Examples thereof include a heat source such as a heater, and a halogen lamp.

Examples of the (2) fixer of the external heating system preferably include an embodiment where at least part of a surface of at least one fixing member out is heated by a heating unit. The beating unit is appropriately selected depending on the intended purpose without any limitation, and examples thereof include an electromagnetic induction heating unit. The electromagnetic induction heating unit is appropriately selected depending on the intended purpose without any limitation, but it is preferably the one containing a unit for generating a magnetic field, and a unit for generating heat by electromagnetic induction. As for the electromagnetic induction heating unit, for example, the one containing a induction coil provided adjacent to the fixing member (e.g., a heating roller), a shielding layer to which the induction coil is provided, and an insulating layer provided to a surface of the shielding layer opposite to the surface thereof where the induction coil is provided is suitably included. In this embodiment, the heating roller is preferably the one formed of a magnetic material, or the one that is a heat pipe. The conduction coil is provided to over at least a half the cylinder of the heating roller at the side which is opposite to the side of the heating roller where the heating roller is in contact with the fixing member (e.g., a pressurizing roller, and an endless belt).

### (Process Cartridge)

The process cartridge for use in the present invention contains at least an electrostatic latent image bearer, and an image developer, and may further contain appropriately selected other units, such as a charger, an irradiator, a transferer, a cleaner, and a discharger, if necessary.

The image developer is a unit configured to develop an electrostatic latent image on the electrostatic latent image bearer with a toner to form a visible image, where the toner is the toner of the present invention.

The image developer contains at least a toner storage container housing the toner therein, and a toner bearer configured to bear and convey the toner housed in the toner container, and may further contain a layer thickness regulating member for regulating a thickness of a toner layer born on the toner bearer. The image developer preferably contains at least a developer storage container housing the two-component developer, and a developer bearer configured to bear and convey the two-component developer housed in the developer storage container. Specifically, the image developer explained in the description of the image forming apparatus is suitably used.

As for the charger, irradiator, transferer, cleaner, and discharger, those explained in the description of the image forming apparatus are appropriately selected and used.

The process cartridge can be detachably mounted in various electrophotographic image forming apparatuses, facsimiles, and printers, and is particularly preferably detachably mounted in the image forming apparatus of the present invention.

The process cartridge is, for example as illustrated in FIG. 2, equipped therein with an electrostatic latent image bearer 101, and contains a charger 102, an image developer 104, a transferer 108, and a cleaner 107, and may further contain other units, if necessary. In FIG. 2, 103 denotes exposure liquid from the irradiator, and 105 denotes a recording medium.

The image forming process in the process cartridge illustrated in FIG. 2 is described next. While rotating the electrostatic latent image bearer 101 in the direction indicated with the arrow, an electrostatic latent image corresponding an exposure image is formed by a surface of the electrostatic latent image bearer 101 as a result of charging by the charger 102, and exposing to light 103 by the irradiator (not illustrated). The electrostatic latent image is developed with a toner by the image developer 104 to form a toner image, and the developed toner image is transferred onto a recording medium 105 by the transferer 108, followed by output as a print. Next, a surface of the electrostatic latent image bearer after the transferring is cleaned by the cleaner 107, discharged by the discharger (not illustrated), and again returned to the aforementioned operation.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Preparation Example 1

### Preparation of Crystalline Resin A1

A reaction tank equipped with a condenser, a stirrer, and a nitrogen inlet tube was charged with 241 parts by weight of sebacic acid, 31 parts by weight of adipic acid, 164 parts by weight of 1,4-butanediol, and as a condensation catalyst, 0.75 parts by weight of titanium dihydroxybis(triethanolaminate), and the resulting mixture was allowed to react for 8 hours at 180° C. under nitrogen gas stream, with removing the generated water. The mixture was then gradually heated to 225° C., and was allowed to react for 4 hours under nitrogen gas stream, with removing the generated water as well as 1,4-butanediol. The resultant was further reacted under the reduced pressure of 5 mmHg to 20 mmHg until Mw of the resultant reached about 18,000, to thereby obtain Crystalline Resin A1 (crystalline polyester resin) having a melting point of 58° C.

### Preparation Example 2

### Preparation of Crystalline Resin A2

A reaction tank equipped with a condenser, a stirrer, and a nitrogen inlet tube was charged with 126 parts by weight of 1,4-butanediol, 215 parts by weight of 1,6-hexanediol, and 100 parts by weight of methyl ethyl ketone (MEK), followed by stirring. To the resultant, 341 parts by weight of hexamethylene diisocyanate (HDI) was added, and the resulting mixture was allowed to react for 8 hours at 80° C. under nitrogen gas stream. Subsequently, MEK was removed by evaporation under the reduced pressure, to thereby obtain Crystalline Resin A2 (crystalline polyurethane resin) having Mw of about 18,000, and a melting point of 59° C.

### Preparation Example 3

### Preparation of Crystalline Resin A3

A reaction tank equipped with a condenser, a stirrer, and a nitrogen inlet tube was charged with 123 parts by weight of 1,4-butanediamine, 211 parts by weight of 1,6-hexanediamine, and 100 parts by weight of methyl ethyl ketone (MEK), and the resulting mixture was stirred. To this, 341 parts by weight of hexamethylene diisocyanate (HDI) was added, and the resulting mixture was allowed to react for 5 hours at 60° C. under nitrogen gas stream. Subsequently, MEK was removed from the reaction mixture by evaporation under the reduced pressure, to thereby obtain Crystalline Resin A3 (crystalline polyurea resin) having Mw of about 22,000, and a melting point of 63° C.

### Preparation Example 4

### Preparation of Crystalline Resin Precursor B1

A reaction tank equipped with a condenser, a stirrer, and a nitrogen inlet tube was charged with 283 parts by weight of sebacic acid, 215 parts by weight of 1,6-hexanediol, and as a condensation catalyst, 1 part by weight of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached about 6,000. The resulting crystalline resin (249 parts by weight) was placed in a reaction tank equipped with a condenser, a stirrer, and a nitrogen inlet tube. To this, 250 parts by weight of ethyl acetate, and 82 parts by weight of hexamethylene diisocyanate (HDI) were added, and the resulting mixture was allowed to react for 5 hours at 80° C. under nitrogen gas stream to prepare an ethyl acetate solution including 50% by weight of Crystalline Resin Precursor B1 (modified polyester resin) having a terminal isocyanate group, Mw of about 22,000 and a melting point of 65° C.

### Preparation Example 5

### Preparation of Non-Crystalline Resin C1

A reaction tank equipped with a condenser, a stirrer, and a nitrogen inlet tube was charged with 240 parts by weight of 1,2-propanediol, 226 parts by weight of terephthalic acid, and as a condensation catalyst 0.64 parts by weight of tetrabutoxy titanate, and the resulting mixture was allowed to react for 8 hours at 180° C. under nitrogen gas stream, with removing the generated methanol. Subsequently, the resultant was gradually heated to 230° C., and was allowed to react for 4 hours under nitrogen gas stream with removing the generated water and 1,2-propanediol, followed by reacted for 1 hour under the reduced pressure of 5 mmHg to 20 mmHg. The resulting reaction mixture was cooled to 180° C., and to this, 8 parts by weight of trimellitic anhydride, and 0.5 parts by weight of tetrabutoxy titanate were added, and the resulting mixture was allowed to react for 1 hour. The resultant was further reacted under the reduced pressure of 5 mmHg to 20 mmHg until Mw of the resultant reached about 7,000, to thereby obtain Non-Crystalline Resin C1 (non-crystalline polyester resin) having a melting point of 61° C.

### Example 1

### Preparation of Particulate Material Dispersion W1

In a reactor vessel including a stirrer and a thermometer, 600 parts of water, 120 parts of styrene, 100 parts of methacrylate, 45 parts of butylacrylate and 10 parts of a sodium salt of alkyl allyl sulfosuccinate (ELEMINOL JS-2 from Sanyo Chemical Industries, Ltd.) and 1 part of persulfate ammonium were mixed, and the mixture was stirred for 20 min at 400 rpm to prepare a white emulsion.

The white emulsion was heated to have a temperature of 75° C. and reacted for 6 hrs.

Further, 30 parts of an aqueous solution of persulfate ammonium having a concentration of 1% were added thereto and the mixture was reacted at 75° C. for 5 hrs to prepare an aqueous dispersion [Particulate Material Dispersion W1] of a vinyl resin (a copolymer of a sodium salt of styrene-methacrylate-butylacrylate-alkyl allyl sulfosuccinate).

The Particulate Material Dispersion W1 had a volume-average particle diameter of 80 nm when measured by LA-920 from Horiba, Ltd. The Particulate Material Dispersion W1 was partially dried to separate the resin therefrom, and the resin had a glass transition temperature (Tg) of 74° C. when measure by the flow tester.

### —Preparation of Aqueous Medium 1—

Nine hundred and ninety (990) parts of ion-exchanged water, 130 parts of the [Particulate Dispersion Liquid W1], 370 parts of an aqueous solution of sodium dodecyldiphenyletherdisulfonate having a concentration of 50% (ELEMINOL MON-7 from Sanyo Chemical Industries, Ltd.), 11 parts of carboxymethylcellulose and 90 parts of ethyl acetate were mixed and stirred at 50° C. to prepare an [Aqueous Medium 1]. A temperature thereof was kept at 50° C. in a container.

### —Preparation of Colorant Master Batch P1—

Crystalline Resin A1 (100 parts by weight), a cyan pigment (C.I. Pigment Blue 15:3) (100 parts by weight), and ion-exchanged water (30 parts by weight) were sufficiently mixed, and kneaded by means of an open-roll kneader (KNEADEX, from Nippon Coke & Engineering Co., Ltd.). As for the kneading temperature, the kneading was initiated at 90° C., followed by gradually cooling to 50° C. In the manner as described, a [Colorant Master Batch P1], in which a ratio (weight ratio) of the resin and the pigment was 1:1, was prepared.

The ion-exchanged water was almost vapored while kneaded and can be disregarded.

### —Preparation of Wax Dispersion—

A reaction vessel equipped with a condenser, a thermometer, and a stirrer was charged with 20 parts by weight of paraffin wax (HNP-9 (melting point: 75° C.), from NIPPON SEIRO CO., LTD.), and 80 parts by weight of ethyl acetate, and the resulting mixture was heated to 78° C. to sufficiently dissolve the wax in the ethyl acetate, followed by cooling to 30° C. over the period of 1 hour with stirring. The resultant was then subjected to wet pulverization by means of ULTRA VISCOMILL (of AIMEX CO., Ltd.) under the following conditions: a liquid feed rate of 1.0 Kg/hr, disc circumferential velocity of 10 m/s, 0.5 mm-zirconia beads packed to 80% by volume, and 6 passes, to thereby obtain a [Wax Dispersion].

### Preparation of Oil Phase 1

A container equipped with a thermometer and a stirrer was charged with 38 parts by weight of the [Crystalline Resin A1], and 38 parts by weight of ethyl acetate, and the resulting mixture was heated to the temperature equal to or higher than the melting point of the resin to sufficiently dissolve the [Crystalline Resin A1]. To this, 88 parts by weight of a 50% by weight of the [Non-Crystalline Resin C1]ethyl acetate solution, 30 parts by weight of the [Wax dispersion], 12 parts by weight of the [Colorant Master Batch P1], and 47 parts by weight of ethyl acetate were added, and the resulting mixture was stirred by means of TK Homomixer (of Tokushu Kika Kogyo Co., Ltd.) at 50° C. and 10,000 rpm to uniformly dissolve and disperse the contents, to thereby obtain an [Oil Phase 1]. Note that, the temperature of the [Oil Phase 1] was kept at 50° C. in the container, and the [Oil Phase 1] was used within 5 hours from the production so as not to crystallize the contents.

### Preparation of Toner 1

Next, a separate container equipped with a stirrer and a thermometer was charged with 100 parts by weight of the [Aqueous Medium 1] having a temperature of 50° C. and 50 parts by weight of the [Oil Phase 1] having a temperature of 50° C., and they were mixed by TK Homomixer (from Tokushu Kika Kogyo Co., Ltd.) at 13,000 rpm and 50° C. for 1 min. Then, the mixture was further mixed at an outer circumferential speed of the stirring blade of 16 m/s under normal pressure at 15° C. for 15 min to prepare an [Emulsified Slurry 1]. The [Emulsified Slurry 1] had an average circularity of 0.947 when measured by the after-mentioned toner evaluation method.

A container equipped with a stirrer and a thermometer was charged with the [Emulsified Slurry 1], and the solvent was removed therefrom over the period of 6 hours at 15° C., to thereby obtain a [Slurry 1].

The obtained mother toner particles in [Slurry 1] (100 parts by weight) were subjected to filtration under the reduced pressure, followed by subjected to the following washing procedure.

(1): ion-exchanged water (100 parts) was added to the filtration cake, followed by mixing with TK Homomixer (at 6,000 rpm for 5 minutes) and then filtration;

(2): a 10% by weight aqueous sodium hydroxide solution (100 parts by weight) was added to the filtration cake obtained in (1), followed by subjected to mixing with TK Homomixer (at 6,000 rpm for 10 minutes) and then filtration under reduced pressure;

(3): a 10% by weight hydrochloric acid (100 parts by weight) was added to the filtration cake obtained in (2), followed by subjected to mixing with TK Homomixer (at 6,000 rpm for 5 minutes) and then filtration; and

(4): ion-exchanged water (300 parts) was added to the filtration cake obtained in (3), followed by mixing with TK Homomixer (at 6,000 rpm for 5 minutes) and then filtration.

This operation was performed twice, to thereby obtain a [Filtration Cake 1].

The [Filtration Cake 1] was dried by means of an air-circulating drier for 48 hours at 45° C., followed by passed through a sieve with a mesh size of 75 to thereby produce [Mother Toner Particles 1].

Next, [Mother Toner Particles 1] (100 parts by weight) were mixed with hydrophobic silica (HDK-2000, from Wacker Chemie AG) (1.0 part by weight) by means of HENSCHEL MIXER, to thereby obtain a [Toner 1] having the volume average particle diameter of 5.8 μm.

### —Preparation of Carrier—

A carrier used in a two-component developer of the invention was prepared in the following manner.

As for a core material, 5,000 parts by weight of Mn ferrite particles (the weight-average particle diameter: 35 μm) were used. As for a coating material, a coating liquid, which had been prepared by stirring 450 parts by weight of toluene, 450 parts by weight of a silicone resin SR2400 (of Dow Corning Toray Co., Ltd., nonvolatile content: 50% by weight), 10 parts by weight of aminosilane SH6020 (of Dow Corning Toray Co., Ltd.), and 10 parts by weight of carbon black for 10 minutes, was used. As for a coating device, a device equipped with a rotatable. The coating device was charged with the core material and the coating liquid to thereby coat the core material with the coating liquid. The coating device was a device equipped with a rotatable bottom plate disk, and a stirring blade, which performed coating by forming swirling air flow in a flow bed of the core material and the coating liquid. The resulting coated product was baked in an electric furnace for 2 hours at 250° C., to thereby obtain [Carrier A].

### —Preparation of Two-Component Developer—

The obtained toner (7 parts by weight) was uniformly mixed with the [Carrier A] (100 parts by weight) by means of TURBULA mixer (from Willy A. Bachofen AG) for 3 minutes at 48 rpm to thereby charge the toner, where the TURBULA mixer was a mixer where a container was driven in rolling motions to perform stirring. In the present invention, a stainless steel container having an internal volume of 500 mL was charged with 200 g of the [Carrier A] and 14 g of the toner to perform mixing.

The thus obtained two-component developer was loaded in an image developer of an intermediate transfer system tandem image forming apparatus (Image Forming Apparatus A) employing a contact charging system, two-component developing system, secondary transferring system, blade cleaning system, and external heating roller fixing system to perform image formation. In the image formation, performance of the toner and developer was evaluated.

Image Forming Apparatus A used in the performance evaluation is specifically explained hereinafter.

### —Image Forming Apparatus A—

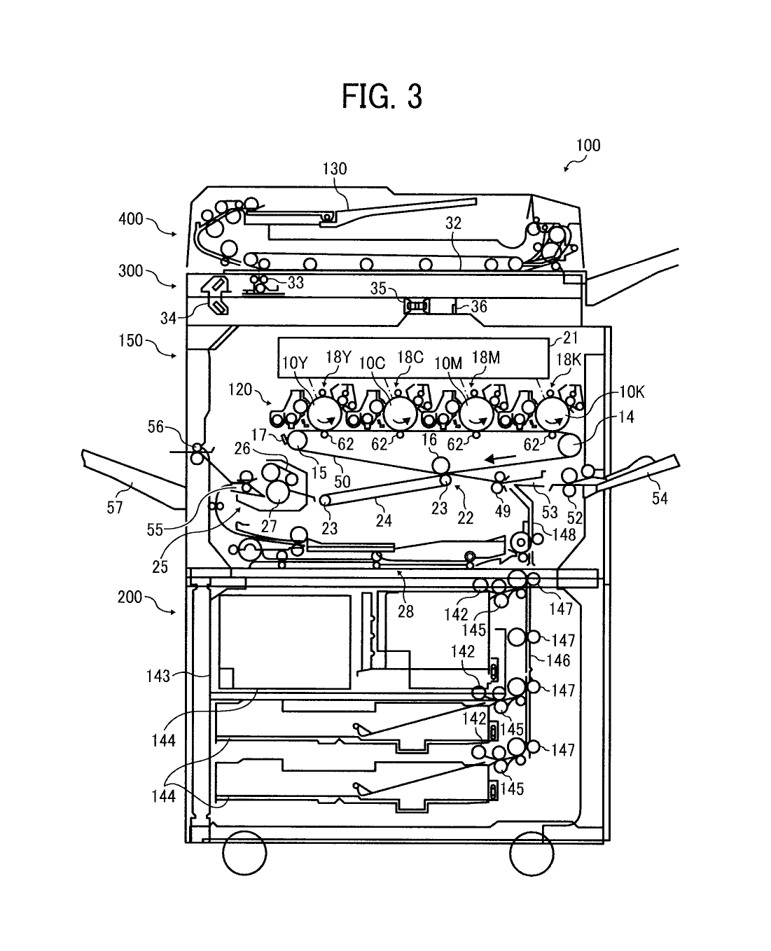

Image Forming Apparatus A 100 illustrated in FIG. 3 is a tandem color image forming apparatus. Image Forming Apparatus A 100 is equipped with a photocopying device main body 150, feeding table 200, scanner 300, and automatic document feeder (ADF) 400.

To photocopying device main body 150, an intermediate transfer member 50 in the form of an endless belt is provided, and is mounted in the center of the main body 150. The intermediate transfer member 50 is rotatably supported by supporting rollers 14, 15 and 16 in the clockwise direction in FIG. 3. In the surrounding area of the supporting roller 15, an intermediate transfer member cleaner 17 configured to remove the residual toner on the intermediate transfer member 50 is provided. To the intermediate transfer member 50 supported by the supporting rollers 14 and 15, a tandem image developer 120, in which four image forming units 18Y, 18C, 18M, 18K, respectively for yellow, cyan, magenta, and black, are aligned parallel to face the intermediate transfer member 50 along the conveying direction of the intermediate transfer member 50. An irradiator 21 is provided adjacent to the tandem image developer 120. A secondary transfer unit 22 is provided to the side of the intermediate transfer member 50, which is opposite to the side thereof where the tandem image developer 120 is provided. In the secondary transfer member 22, a secondary transfer belt 24 in the form of an endless belt is supported by a pair of rollers 23, and is designed so that a recording medium conveyed on the secondary transfer belt 24 can be in contact with the intermediate transfer member 50. A fixer 25 is provided adjacent to the secondary transfer unit 22.

Note that, in Image Forming Apparatus A 100, a reversing device 28 is provided adjacent to the secondary transfer unit 22 and the fixer 25, where the reversing device 28 is configured to reverse a recording medium to perform image formation on both sides of the recording medium.

Next, formation of a full color image by means of the tandem image developer 120 is explained.

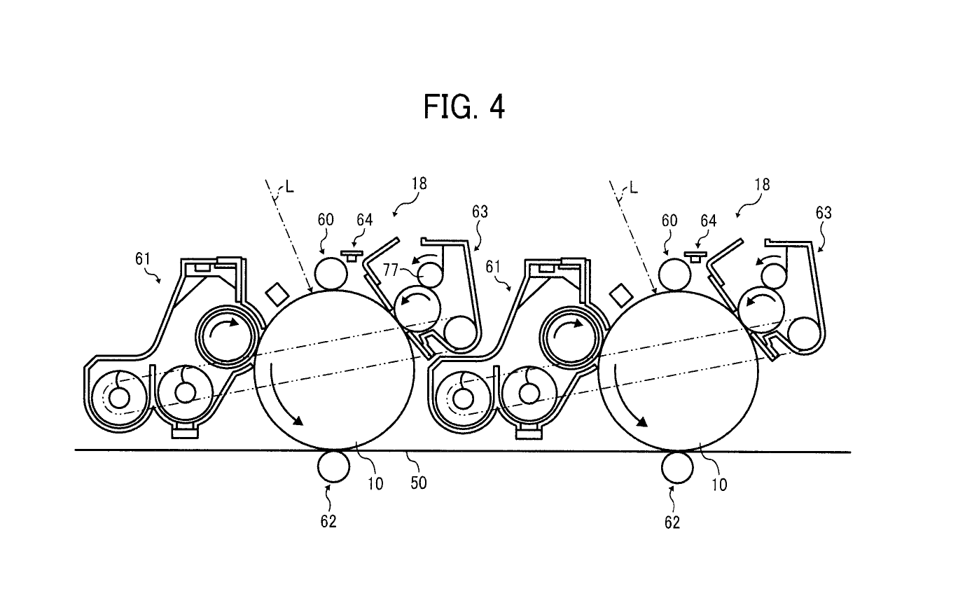

Specifically, a document is, first, set on a document table 130 of the automatic document feeder (ADF) 400, or set on a contact glass 32 of a scanner 300 after opening the automatic document feeder 400, followed by closing the automatic document feeder 400. As a start switch (not illustrated) is pressed, in the case where the document is set in the automatic document feeder 400, the document is transported onto the contact glass 32, and then the scanner 300 is driven to scan a first scanning carriage 33 and a second scanning carriage 34. In the case where the document is set on the contact glass 32, the scanner 300 is driven immediately after the start switch is pressed. During this operation, as well as applying light from a light source of the first scanning carriage 33, the reflected light from the surface of the document is reflected by a mirror of the second scanning carriage 34. The reflected light is then passed through a imaging lens 35, and received by a reading sensor 36 to be read as a color document (color image), which constitutes image information of black, yellow, magenta and cyan. Each image information of black, yellow, magenta, or cyan is transmitted to a respective image forming unit 18 (black image forming unit 18K, yellow image forming unit 18Y, magenta image forming unit 18M, or cyan image forming unit 18C) of the tandem image developer 120, and each toner image of black, yellow, magenta, or cyan is formed by the respective image forming unit. Specifically, each image forming unit 18 (black image forming unit 18K, yellow image forming unit 18Y, magenta image forming unit 18M, or cyan image forming unit 18C) in the tandem image developer 120 is, as illustrated in FIG. 4, equipped with: an electrostatic latent image bearer 10 (electrostatic latent image bearer for black 10K, electrostatic latent image bearer for yellow 10Y, electrostatic latent image bearer for magenta 10M, or electrostatic latent image bearer for cyan 10C); a charger 60 configured to uniformly charge the electrostatic latent image bearer; an irradiator configured to apply imagewise light (L in FIG. 4) to the respective electrostatic latent image bearer corresponding to the respective color image information to form an electrostatic latent image corresponding to each color image on the electrostatic latent image bearer; an image developer 61 configured to develop the electrostatic latent image with each color toner (black toner, yellow toner, magenta toner, or cyan toner) to form a respective toner image; a transfer charger 62 for transferring the toner image to an intermediate transfer member 50; a cleaner 63; and a discharger 64, and each image forming unit 18 can form a respective monochrome image (black image, yellow image, magenta image, and cyan image) corresponding to the respective color image information. The black image, yellow image, magenta image and cyan image formed in the aforementioned manner are respectively transferred to the intermediate transfer member 50 rotatably supported by the supporting rollers 14, 15, and 16. Specifically, the black image formed on the electrostatic latent image bearer for black 10K, the yellow image formed on the electrostatic latent image bearer for yellow 10Y, the magenta image formed on the electrostatic latent image bearer for magenta 10M, and the cyan image formed on the electrostatic latent image bearer 10C are successively transferred (primary transferred) onto the intermediate transfer member 50. Then, the black image, yellow image, magenta image, and cyan image are superimposed on the intermediate transfer member 50 to thereby form a composite color image (color transfer image).

Meanwhile, in the feeding table 200, recording media is sent out from one of feeding cassettes 144 multiply equipped in a paper bank 143, by selectively rotating one of the feeding rollers 142, and the recording media is separated one by one with a separation roller 145 to send into a feeding path 146. The separated recording medium is then transported by the transporting roller 147 to guide into the feeding path 148 inside the photocopying device main body 150, and is bumped against the registration roller 49 to stop. Alternatively, the recording media on a manual-feeding tray 54 is ejected by rotating a feeding roller 142, separated one by one with a separation roller 52 to guide into a manual feeding path 53, and then stopped against the registration roller 49 in the similar manner. Note that, the registration roller 49 is generally earthed at the time of the use, but it may be biased for removing paper dust of the recording medium. The registration roller 49 is then rotated synchronously with the movement of the composite color image (color transfer image) formed on the intermediate transfer member 50, the recording medium is sent in between the intermediate transfer member 50 and a secondary transfer member 22, and the composite color image (color transfer image) is then transferred (secondary transferred) onto the recording medium by the secondary transfer unit 22, to thereby transfer and form the color image onto the recording medium. Note that, the residual toner on the intermediate transfer member 50 after the transferring of image is cleaned by an intermediate transfer member cleaner 17.

The recording medium on which the color image has been transferred and formed is transported by the secondary transfer member 22 to send to a fixer 25, and the composite color image (color transfer image) is fixed to the recording medium by heat and pressure applied by the fixer 25. Thereafter, the recording medium was changed its traveling direction by a switch craw 55, and ejected onto an output tray 57 by an ejecting roller 56. Alternatively, the recording medium is changed its traveling direction by the switch craw 55, reversed by the reversing device 28 to form an image on the back surface of the recording medium in the same manner as mentioned above, and then ejected onto the output tray 57 by the ejecting roller 56. Note that, in FIG. 3, the reference signs 26 and 27 respectively denote a fixing belt and a pressure roller.

A damage of an image by transporting due to recrystallization just after thermal fixing, prevention of which is one of the problems to be solved by the present invention, occurs in Image Forming Apparatus A 100 when a recording medium passes through a discharging roller 56 or transporting roller provided in the reversing device 28.

### <Evaluation>

The evaluation methods for the binder resin for use, toner, and developer will be specifically explained hereinafter.

### <<Melting Point Ta and Softening Point Tb of Binder Resin and Toner, and Ratio Ta/Tb of Melting Point to Softening Point>>

The melting points (the maximum peak temperature of heat of melting, Ta) of the binder resin and toner were measured by a differential scanning calorimeter (DSC)(TA-60WS and DSC-60, from Shimadzu Corporation). A sample provided for the measurement of the maximum peak of heat of melting was subjected to the pretreatment. As for the pretreatment, the sample was melted at 130° C., followed by cooling from 130° C. to 70° C. at the cooling rate of 1.0° C./min. The sample was then cooled from 70° C. to 10° C. at the cooling rate of 0.5° C./min. The sample was subjected to the measurement of endothermic and exothermic changes in DSC by heating at the heating rate of 20° C., to thereby plot “absorption or evolution heat capacity” verses “temperature” in a graph. The endothermic peak temperature in the range of 20° C. to 100° C. appeared in the graph was determined as “Ta*.” Note that, in the case where there were few endothermic peaks, the temperature of the peak having the largest endothermic value was determined as Ta*. Thereafter, the sample was stored for 6 hours at the temperature of (Ta*−10)° C., followed by stored for 6 hours at the temperature of (Ta*−15)° C. Next, the sample was cooled to 0° C. at the cooling rate of 10° C./min., heated at the heating rate of 20° C./min. to measure the endothermic and exothermic changes by means of DSC, creating a graph in the same manner as the above. In the graph, the temperature corresponding to the maximum peak of the absorption or evolution heat capacity was determined as the maximum peak temperature of heat of melting.

The softening points (Tb) of the binder resins and the toners were measured by means of an elevated flow tester (e.g., CFT-500D, from Shimadzu Corporation). As a sample, 1 g of the binder resin or toner was used. The sample was heated at the heating rate of 6° C./min., and at the same time, load of 1.96 Mpa was applied by a plunger to extrude the sample from a nozzle having a diameter of 1 mm and length of 1 mm, during which an amount of the plunger of the flow tester pushed down relative to the temperature was plotted. The temperature at which half of the sample was flown out was determined as a softening point of the sample.

### <<Circularity of Emulsified Particles and Mother Toner Particles>>

The circularity of the Emulsified Particles and Mother Toner Particles were measured by a flow type particle image analyzer FPIA-2100 from To a Medical Electronics Co., Ltd., and analyzed using an analysis software FPIA-2100 Data Processing ‘Program for FPIA version 00-10).

Specifically, 0.1 to 0.5 g of the toner and 0.1 to 0.5 ml of a surfactant (alkylbenzenesulfonate Neogen SC-A from Dai-ichi Kogyo Seiyaku Co., Ltd.) having a concentration of 10% by weight were mixed by a micro spatel in a glass beaker having a capacity of 100 ml, and 80 ml of ion-exchange water was added to the mixture. Further, the mixture was dispersed by an ultrasonic disperser UH-50 from STM Corp. at 20 kHz, 50 W/10 cm³ for 1 min to prepare a dispersion. The dispersion is further dispersed for totally 5 min to include the particles having a circle-equivalent diameter of from 0.60 to less than 159.21 μm in an amount of 4,000 to 8,000/10⁻³ cm³ and the particle diameter distribution thereof was measured.

The sample dispersion is passed through a flow path (expanding along the flowing direction) of a flat and transparent flow cell (having a thickness of 200 μm). A strobe light and a CCD camera are located facing each other across the flow cell to form a light path passing across the thickness of the flow cell. While the sample dispersion flows, strobe light is irradiated to the particles at an interval of 1/30 sec to obtain images thereof flowing on the flow cell, and therefore a two-dimensional image of each particle having a specific scope parallel to the flow cell is photographed. From the two-dimensional image, the diameter of a circle having the same area is determined as a circle-equivalent diameter. The circle-equivalent diameters of 1,200 or more of the particles can be measured and a ratio (% by number) of the particles have a specified circle-equivalent diameter can be measured.

Results (frequency % and accumulation %) can be obtained, dividing 0.06 to 400 μm into 226 channels (30 channel/octave). Actually, the particles having a circle-equivalent diameter of from 0.60 to less than 159.21 μm are measured. The results are shown in Table 4.

### <<Cleanability>>

Untransferred residual toners after 1,000 pieces of A4-size solid images having a toner adherence amount of 0.5 mg/cm² were produced and after 100,000 pieces thereof were transferred onto a blank paper using Scotch Tape from Sumitomo 3M Ltd. to measure the density with Macbeth Reflection Densitometer RD514. The cleanability was evaluated according to the following standard.

Good: a difference in density is 0.01 or less

Poor: a difference in density is over 0.01

### <<Low-Temperature Fixability (Fixable Minimum Temperature)>>

Using Image Forming Apparatus A, a solid image (the image size: 3 cm×8 cm) having a toner deposition amount of 0.85 mg/cm²±0.1 mg/cm² (after transferring) on transfer paper (Copy Print Paper <70>, of Ricoh Business Expert, Ltd.) was formed, and the transferred image was fixed with varying the temperature of the fixing belt. The surface of the obtained fixed image was drawn with a ruby needle (point diameter: 260 μm to 320 μm, point angle: 60 degrees) by means of a drawing tester AD-401 (from Ueshima Seisakusho Co., Ltd.) with a load of 50 g. The drawn surface was rubbed 5 times with fibers (HaniCot #440, available from Sakata Inx Eng. Co., Ltd.). The temperature of the fixing belt at which hardly any image was scraped in the resulting image was determined as the fixable minimum temperature. Moreover, the solid image was formed in the position of the transfer paper, which was 3.0 cm from the edge of the paper from which the sheet was fed. Note that, the speed of the sheet passing the nip in the fixing device was 280 mm/s. The lower the fixable minimum temperature is, more excellent the low-temperature fixability of the toner is. The results are presented in Table 5.

[Evaluation Standard]

Excellent: Fixable minimum temperature is less than 110° C.

Good: Fixable minimum temperature is 110° C. or more and less than 120° C.

Fair: Fixable minimum temperature is 120° C. or more and less than 130° C.

Poor: Fixable minimum temperature is 130° C. or more

### <<Hot Offset Resistance (Fixable Temperature Range)>>

Using Image Forming Apparatus A, a solid image (the image size: 3 cm×8 cm) having a toner deposition amount of 0.85 mg/cm²±0.1 mg/cm² (after transferring) on transfer paper (Type 6200, from Ricoh Company Limited) was formed, and the transferred image was fixed with varying the temperature of the fixing belt. Then, occurrences of hot offset was visually evaluated, and the temperature range between the upper temperature at which the hot offset did not occur, and the minimum fixing temperature was determined as the fixable temperature range. Moreover, the solid image was formed in the position of the transfer paper, which was 3.0 cm from the edge of the paper from which the sheet was fed. Note that, the speed of the sheet passing the nip in the fixing device was 280 mm/s. The toner has more excellent hot offset resistance as the fixable temperature range widens, and about 50° C. is the average fixable temperature range of a conventional full color toner. The results are presented in Table 5.

[Evaluation Standard]

Excellent: Fixable temperature range is 60° C. or more

Good: Fixable temperature range is 50° C. or more and less than 60° C.

Fair: Fixable temperature range is 40° C. or more and less than 50° C.

Poor: Fixable temperature range is less than 40° C.

### <<Heat Resistance Storage Stability>>

A 50 mL glass container was filled with the toner, and the container was left to stand in a thermostat of 50° C. for 24 hours, followed by cooling to 24° C. The resulting toner was subjected to a penetration degree test (JIS K2235-1991) to thereby measure a penetration degree (mm), and the result was evaluated in terms of the heat resistance storage stability based on the following criteria. The greater the penetration degree is, more excellent the heat resistance storage stability of the toner is. The toner having the penetration degree of lower than 150 more likely causes a problem on practice. The results are presented in Table 5.

[Evaluation Standard]

Excellent: Penetration degree is 250 or more

Good: Penetration degree is 200 or more and less than 250

Fair: Penetration degree is 150 or more and less than 200

Poor: Penetration degree is less than 150

### Example 2

### Preparation of Toner 2

A separate container equipped with a stirrer and a thermometer was charged with 100 parts by weight of the [Aqueous Medium 1] having a temperature of 50° C. and 50 parts by weight of the [Oil Phase 1] having a temperature of 50° C., and they were mixed by TK Homomixer (from Tokushu Kika Kogyo Co., Ltd.) at 13,000 rpm for 1 min. Then, the mixture was further mixed at an outer circumferential speed of the stirring blade of 16 m/s under normal pressure at 15° C. for 15 min to prepare an emulsified dispersion. The emulsified dispersion had an average circularity of 0.947. The temperature of the emulsified dispersion was increased to 25° C. and further stirred for 5 min. The emulsified dispersion had an average circularity of 0.953. The temperature of the emulsified dispersion was increased to 30° C. and further stirred for 5 min. The emulsified dispersion had an average circularity of 0.961. Then, stirring was stopped to prepare an [Emulsified Slurry 2].

A container equipped with a stirrer and a thermometer was charged with the [Emulsified Slurry 2], and the solvent was removed therefrom over the period of 6 hours at 15° C., to thereby obtain a [Slurry 2].

The procedure for preparation of the [Toner 1] in Example 1 was repeated to prepare a [Toner 2] except for replacing the [Slurry 1] with the [Slurry 2].

### Example 3

### Preparation of Colorant Master Batch P3

The procedure for preparation of the [Colorant Master Batch P1] was repeated to prepare a [Colorant Master Batch P3] except for replacing the [Crystalline Resin A1] with the [Crystalline Resin A2].

### Preparation of Toner 3

The procedure for preparation of the [Emulsified Slurry 1] in Example 1 was repeated to prepare a [Emulsified Slurry 3] except for replacing the [Crystalline Resin A1] with the [Crystalline Resin A2] and the [Colorant Master Batch P1] with the [Colorant Master Batch P3], respectively. The average circularity was 0.944. The [Emulsified Slurry 3] was processed to a [Slurry 3] as the [Emulsified Slurry 1] was processed to the [Slurry 1] in Example 1.

The procedure for preparation of the [Toner 1] in Example 1 was repeated to prepare a [Toner 3] except for replacing the [Slurry 1] with the [Slurry 3].

### Example 4

### Preparation of Colorant Master Batch P4

The procedure for preparation of the [Colorant Master Batch P1] was repeated to prepare a [Colorant Master Batch P4] except for replacing the [Crystalline Resin A1] with the [Crystalline Resin A3].

### Preparation of Oil Phase 4

A container equipped with a thermometer and a stirrer was charged with 38 parts by weight of the [Crystalline Resin A3], and 38 parts by weight of ethyl acetate, and the resulting mixture was heated to the temperature equal to or higher than the melting point of the resin to sufficiently dissolve the [Crystalline Resin A3]. To this, 30 parts by weight of the [Wax dispersion], 12 parts by weight of the [Colorant Master Batch P4], and 46 parts by weight of ethyl acetate were added, and the resulting mixture was stirred by means of TK Homomixer (of Tokushu Kika Kogyo Co., Ltd.) at 50° C. and 10,000 rpm, and further 88 parts by weight of a 50% by weight of the [Crystalline Resin Precursor B1]ethyl acetate solution were added to this, and the resulting mixture was stirred by means of TK Homomixer (of Tokushu Kika Kogyo Co., Ltd.) at 50° C. and 10,000 rpm to uniformly dissolve and disperse the contents, to thereby obtain an [Oil Phase 4]. Note that, the temperature of the [Oil Phase 4] was kept at 50° C. in the container, and the [Oil Phase 4] was used within 5 hours from the production so as not to crystallize the contents.

### Preparation of Toner 4

Next, a separate container equipped with a stirrer and a thermometer was charged with 140 parts by weight of the [Aqueous Medium 1] having a temperature of 50° C., 80 parts by weight of the [Oil Phase 4] having a temperature of 50° C. and 7.5 parts of isophoronediamine, and they were mixed by TK Homomixer (from Tokushu Kika Kogyo Co., Ltd.) at 13,000 rpm and 50° C. for 1 min. Then, the mixture was further mixed at an outer circumferential speed of the stirring blade of 16 m/s under normal pressure at 15° C. for 15 min to prepare an [Emulsified Slurry 4]. The [Emulsified Slurry 4] had an average circularity of 0.945 when measured by the after-mentioned toner evaluation method. The [Emulsified Slurry 4] was processed to a [Slurry 4] as the [Emulsified Slurry 1] was processed to the [Slurry 1] in Example 1.

The procedure for preparation of the [Toner 1] in Example 1 was repeated to prepare a [Toner 4] except for replacing the [Slurry 1] with the [Slurry 4].

### —Preparation of Aqueous Medium 5—

Nine hundred and seventy five (975) parts of ion-exchanged water, 45 parts of the [Particulate Dispersion Liquid W1], 370 parts of an aqueous solution of sodium dodecyldiphenyletherdisulfonate having a concentration of 50% (ELEMINOL MON-7 from Sanyo Chemical Industries, Ltd.), 11 parts of carboxymethylcellulose and 90 parts of ethyl acetate were mixed and stirred at 50° C. to prepare an [Aqueous Medium 5]. A temperature thereof was kept at 50° C. in a container.

### Preparation of Toner 5

The procedure for preparation of the [Emulsified Slurry 1] in Example 1 was repeated to prepare an [Emulsified Slurry 5] except for replacing the [Aqueous Medium 1] with the [Aqueous Medium 5]. The [Emulsified Slurry 5] had an average circularity of 0.952. The [Emulsified Slurry 5] was processed to a [Slurry 5] as the [Emulsified Slurry 1] was processed to the [Slurry 1] in Example 1.

The procedure for preparation of the [Toner 1] in Example 1 was repeated to prepare a [Toner 5] except for replacing the [Slurry 1] with the [Slurry 5].

### Example 6

### Preparation of Toner 6

A separate container equipped with a stirrer and a thermometer was charged with 100 parts by weight of the [Aqueous Medium 5] having a temperature of 50° C. and 50 parts by weight of the [Oil Phase 1] having a temperature of 50° C., and they were mixed by TK Homomixer (from Tokushu Kika Kogyo Co., Ltd.) at 13,000 rpm for 1 min. Then, the mixture was further mixed at an outer circumferential speed of the stirring blade of 16 m/s under normal pressure at 15° C. for 15 min to prepare an emulsified dispersion. The emulsified dispersion had an average circularity of 0.952. The temperature of the emulsified dispersion was increased to 25° C. and further stirred for 5 min. The emulsified dispersion had an average circularity of 0.963. Then, stirring was stopped to prepare an [Emulsified Slurry 6].

A container equipped with a stirrer and a thermometer was charged with the [Emulsified Slurry 6], and the solvent was removed therefrom over the period of 6 hours at 15° C., to thereby obtain a [Slurry 6].

The procedure for preparation of the [Toner 1] in Example 1 was repeated to prepare a [Toner 6] except for replacing the [Slurry 1] with the [Slurry 6].

### Example 7

### Production of Layered Inorganic Mineral Master Batch F1

Crystalline Resin A1 (100 parts by weight), a montmorillonite compound modified with a quaternary ammonium salt including a benzyl group at least a part thereof (CLAYTONE APA, from Southern Clay Products Inc.) (100 parts by weight), and ion-exchanged water (50 parts by weight) were sufficiently mixed, and kneaded by means of an open-roll kneader (KNEADEX, from Nippon Coke & Engineering Co., Ltd.). As for the kneading temperature, the kneading was initiated at 90° C., followed by gradually cooling to 50° C. In the manner as described, a [Layered Inorganic Mineral Master Batch F1], in which a ratio (weight ratio) of the resin and the layered inorganic mineral was 1:1, was produced.

The ion-exchanged water was almost vapored while kneaded and can be disregarded.

### Preparation of Oil Phase 7

A container equipped with a thermometer and a stirrer was charged with 37 parts by weight of the [Crystalline Resin A1], and 37 parts by weight of ethyl acetate, and the resulting mixture was heated to the temperature equal to or higher than the melting point of the resin to sufficiently dissolve the [Crystalline Resin A1]. To this, 88 parts by weight of a 50% by weight of the [Non-Crystalline Resin C1]ethyl acetate solution, 30 parts by weight of the [Wax dispersion], 2 parts by weight of the [Layered Inorganic Mineral Master Batch F1], 12 parts by weight of the [Colorant Master Batch P1], and 47 parts by weight of ethyl acetate were added, and the resulting mixture was stirred by means of TK Homomixer (of Tokushu Kika Kogyo Co., Ltd.) at 50° C. and 10,000 rpm to uniformly dissolve and disperse the contents, to thereby obtain an [Oil Phase 7]. Note that, the temperature of the [Oil Phase 7] was kept at 50° C. in the container, and the [Oil Phase 7] was used within 5 hours from the production so as not to crystallize the contents.

### Preparation of Toner 7

The procedure for preparation of the [Emulsified Slurry 1] in Example 1 was repeated to prepare an [Emulsified Slurry 7] except for replacing the [Oil Phase 1] with the [Oil Phase 7]. The [Emulsified Slurry 7] had an average circularity of 0.943. The [Emulsified Slurry 7] was processed to a [Slurry 7] as the [Emulsified Slurry 1] was processed to the [Slurry 1] in Example 1.

The procedure for preparation of the [Toner 1] in Example 1 was repeated to prepare a [Toner 7] except for replacing the [Slurry 1] with the [Slurry 7].

### Example 8

### Preparation of Toner 8

A separate container equipped with a stirrer and a thermometer was charged with 100 parts by weight of the [Aqueous Medium 1] having a temperature of 50° C. and 50 parts by weight of the [Oil Phase 7] having a temperature of 50° C., and they were mixed by TK Homomixer (from Tokushu Kika Kogyo Co., Ltd.) at 13,000 rpm for 1 min. Then, the mixture was further mixed at an outer circumferential speed of the stirring blade of 16 m/s under normal pressure at 15° C. for 15 min to prepare an emulsified dispersion. The emulsified dispersion had an average circularity of 0.943. The temperature of the emulsified dispersion was increased to 30° C. and further stirred for 5 min. The emulsified dispersion had an average circularity of 0.954. The temperature of the emulsified dispersion was increased to 37° C. and further stirred for 5 min. The emulsified dispersion had an average circularity of 0.961. Then, stirring was stopped to prepare an [Emulsified Slurry 8].

A container equipped with a stirrer and a thermometer was charged with the [Emulsified Slurry 8], and the solvent was removed therefrom over the period of 6 hours at 37° C., to thereby obtain a [Slurry 8].

The procedure for preparation of the [Toner 1] in Example 1 was repeated to prepare a [Toner 8] except for replacing the [Slurry 1] with the [Slurry 8].

### Comparative Example 1

### Preparation of Toner 9

A separate container equipped with a stirrer and a thermometer was charged with 100 parts by weight of the [Aqueous Medium 1] having a temperature of 50° C. and 50 parts by weight of the [Oil Phase 1] having a temperature of 50° C., and they were mixed by TK Homomixer (from Tokushu Kika Kogyo Co., Ltd.) at 13,000 rpm for 1 min. Then, the mixture was further mixed at an outer circumferential speed of the stirring blade of 16 m/s under normal pressure at 50° C. for 15 min to prepare an [Emulsified Slurry 9]. The [Emulsified Slurry 9] had an average circularity of 0.983.

A container equipped with a stirrer and a thermometer was charged with the [Emulsified Slurry 9], and the solvent was removed therefrom over the period of 6 hours at 25° C., to thereby obtain a [Slurry 9].

The procedure for preparation of the [Toner 1] in Example 1 was repeated to prepare a [Toner 9] except for replacing the [Slurry 1] with the [Slurry 9].

### Comparative Example 2

### Preparation of Oil Phase 10

A container equipped with a thermometer and a stirrer was charged with 29 parts by weight of the [Crystalline Resin A1], and 29 parts by weight of ethyl acetate, and the resulting mixture was heated to the temperature equal to or higher than the melting point of the resin to sufficiently dissolve the [Crystalline Resin A1]. To this, 106 parts by weight of a 50% by weight of the [Non-Crystalline Resin C1]ethyl acetate solution, 30 parts by weight of the [Wax dispersion], 12 parts by weight of the [Colorant Master Batch P1], and 46 parts by weight of ethyl acetate were added, and the resulting mixture was stirred by means of TK Homomixer (of Tokushu Kika Kogyo Co., Ltd.) at 50° C. and 10,000 rpm to uniformly dissolve and disperse the contents, to thereby obtain an [Oil Phase 10]. Note that, the temperature of the [Oil Phase 10] was kept at 50° C. in the container, and the [Oil Phase 10] was used within 5 hours from the production so as not to crystallize the contents.

### Preparation of Toner 10

A separate container equipped with a stirrer and a thermometer was charged with 100 parts by weight of the [Aqueous Medium 1] having a temperature of 50° C. and 50 parts by weight of the [Oil Phase 10] having a temperature of 50° C., and they were mixed by TK Homomixer (from Tokushu Kika Kogyo Co., Ltd.) at 13,000 rpm for 1 min. Then, the mixture was further mixed at an outer circumferential speed of the stirring blade of 16 m/s under normal pressure at 15° C. for 15 min to prepare an [Emulsified Slurry 10]. The [Emulsified Slurry 10] had an average circularity of 0.952.

A container equipped with a stirrer and a thermometer was charged with the [Emulsified Slurry 10], and the solvent was removed therefrom over the period of 6 hours at 25° C., to thereby obtain a [Slurry 10].

The procedure for preparation of the [Toner 1] in Example 1 was repeated to prepare a [Toner 10] except for replacing the [Slurry 1] with the [Slurry 10].

TABLE 1

| | | | | Tg | Ta | Tb | Tb/ |
|---|---|---|---|---|---|---|---|
| Binder Resin | | Resin | Mw | (° C.) | (° C.) | (° C.) | Ta |
| Crystalline | A1 | Polyester | 18000 | — | 58 | 56 | 0.97 |
| Resin | A2 | Poly- | 18000 | — | 59 | 69 | 1.17 |
| | | urethane | | | | | |
| | A3 | Polyurea | 22000 | — | 63 | 65 | 1.03 |
| Crystalline | B1 | Modified | 20000 | — | 65 | 76 | 1.17 |
| Resin precursor | | polyester | | | | | |
| Non-Crystalline | C1 | Polyester | 7000 | 55 | 61 | 137 | 2.25 |
| Resin | | | | | | | |

TABLE 2

| | | Binder Resin | | | | | |
|---|---|---|---|---|---|---|---|
| | | | | Crystalline | | Non- | |
| | | Crystalline | | Resin | | Crystalline | |
| | | Resin | | Precursor | | Resin | |
| | Toner | | Wt % | | Wt % | | Wt % |
| Example 1 | Toner 1 | A1 | 50 | | | C1 | 50 |
| Example 2 | Toner 2 | A1 | 50 | | | C1 | 50 |
| Example 3 | Toner 3 | A2 | 50 | | | C1 | 50 |
| Example 4 | Toner 4 | A3 | 50 | B1 | 50 | | |
| Example 5 | Toner 5 | A1 | 50 | | | C1 | 50 |
| Example 6 | Toner 6 | A1 | 50 | | | C1 | 50 |
| Example 7 | Toner 7 | A1 | 50 | | | C1 | 50 |
| Example 8 | Toner 8 | A1 | 50 | | | C1 | 50 |
| Comparative | Toner 9 | A1 | 50 | | | C1 | 50 |
| Example 1 | | | | | | | |
| Comparative | Toner 10 | A1 | 40 | | | C1 | 50 |
| Example 2 | | | | | | | |

TABLE 3

| | | Emulsified | Mother Toner Granulation Process | | | | | |
|---|---|---|---|---|---|---|---|---|
| | | Dispersion | Temp. Cntrl. 1 | | Temp. Cntrl. 2 | | Temp. Cntrl. 3 | |
| | | Preparation | | Circu- | | Circu- | | Circu- |
| | Toner | Temperature | ° C. | larity | ° C. | larity | ° C. | larity |
| Example 1 | Toner 1 | 50 | 15 | 0.947 | — | | — | |
| Example 2 | Toner 2 | 50 | 15 | 0.947 | 25 | 0.953 | 30 | 0.961 |
| Example 3 | Toner 3 | 50 | 15 | 0.944 | — | | — | |
| Example 4 | Toner 4 | 50 | 15 | 0.945 | — | | — | |
| Example 5 | Toner 5 | 50 | 15 | 0.952 | — | | — | |
| Example 6 | Toner 6 | 50 | 15 | 0.952 | 25 | 0.963 | — | |
| Example 7 | Toner 7 | 50 | 15 | 0.943 | — | | — | |
| Example 8 | Toner 8 | 50 | 15 | 0.943 | 30 | 0.954 | 37 | 0.961 |
| Comparative | Toner 9 | 50 | 50 | 0.983 | — | | — | |
| Example 1 | | | | | | | | |
| Comparative | Toner 10 | 50 | 15 | 0.952 | — | | — | |
| Example 2 | | | | | | | | |

TABLE 4

| | | | Thermal Properties | | |
|---|---|---|---|---|---|
| | | Mother Toner | Ta | Tb | |
| | Toner | Circularity | (° C.) | (° C.) | Tb/Ta |
| Example 1 | Toner 1 | 0.945 | 58 | 62 | 1.07 |
| Example 2 | Toner 2 | 0.960 | 58 | 62 | 1.07 |
| Example 3 | Toner 3 | 0.944 | 58 | 74 | 1.28 |
| Example 4 | Toner 4 | 0.942 | 65 | 81 | 1.25 |
| Example 5 | Toner 5 | 0.950 | 62 | 68 | 1.10 |
| Example 6 | Toner 6 | 0.961 | 62 | 68 | 1.10 |
| Example 7 | Toner 7 | 0.942 | 59 | 63 | 1.07 |
| Example 8 | Toner 8 | 0.961 | 59 | 63 | 1.07 |
| Comparative | Toner 9 | 0.983 | 58 | 62 | 1.07 |
| Example 1 | | | | | |
| Comparative | Toner 10 | 0.951 | 59 | 80 | 1.36 |
| Example 2 | | | | | |

TABLE 5

| | | | Fixability | | |
|---|---|---|---|---|---|
| | | | Fixable | | Heat |
| | | | Minimum | Fixable | Resistance |
| | | Clean- | Tempera- | Temperature | Storage |
| | Toner | ability | ture [° C.] | Range [° C.] | Stability |
| Example 1 | Toner 1 | Good | Excellent | Fair | Fair |
| Example 2 | Toner 2 | Good | Excellent | Fair | Fair |
| Example 3 | Toner 3 | Good | Good | Excellent | Good |
| Example 4 | Toner 4 | Good | Excellent | Excellent | Excellent |
| Example 5 | Toner 5 | Good | Good | Good | Good |
| Example 6 | Toner 6 | Good | Good | Good | Good |
| Example 7 | Toner 7 | Good | Excellent | Fair | Fair |
| Example 8 | Toner 8 | Good | Excellent | Fair | Fair |
| Comparative | Toner 9 | Poor | Excellent | Fair | Good |
| Example 1 | | | | | |
| Comparative | Toner 10 | Good | Excellent | Fair | Poor |
| Example 2 | | | | | |

Having now fully described the invention, it will be apparent to one of ordinary skill in the art that many changes and modifications can be made thereto without departing from the spirit and scope of the invention as set forth therein.

What is claimed is:

1. A toner for electrophotography, which is prepared by a method comprising:
dissolving or dispersing a toner composition comprising at least a binder resin, or binder resin and a binder resin precursor as a resin component; and a colorant in an organic solvent to form an oil phase;
emulsifying or dispersing the oil phase in an aqueous medium to form an emulsion dispersion comprising emulsified particles;
converging the emulsified particles to granulate mother toner particles, comprising controlling a temperature of the emulsion dispersion to control a circularity of the mother toner particles; and
removing the organic solvent,
wherein the resin component comprises a crystalline resin in an amount not less than 50% by weight, and the mother toner particles have an average circularity of from 0.940 to 0.980.

2. The toner of claim 1, wherein the step of converging the emulsified particles comprises:
increasing the temperature of the emulsion dispersion to control the circularity of the mother toner particles.

3. The toner of claim 1, wherein the toner composition further comprises an organic-modified layered inorganic mineral.

4. The toner of claim 3, wherein the organic-modified layered inorganic mineral is a smectite clay mineral in which at least a part of ions present between layers thereof is modified with an organic cation.

5. The toner of claim 3, wherein the organic-modified layered inorganic mineral is montmorillonite in which at least a part of ions present between layers thereof is modified with an organic cation.

6. The toner of claim 1, wherein the crystalline resin comprises at least one of a urethane skeleton and a urea skeleton.

7. The toner of claim 6, wherein the crystalline resin is a straight-chain polyester resin or a composite resin comprising the straight-chain polyester resin.

8. The toner of claim 1, wherein the mother toner particles have an average circularity of from 0.950 to 0.970.

9. A developer comprising the toner according to claim 1.

10. A method of preparing toner for electrophotography, comprising:
dissolving or dispersing a toner composition comprising at least a binder resin, or binder resin and a binder resin precursor as a resin component; and a colorant in an organic solvent to form an oil phase;
emulsifying or dispersing the oil phase in an aqueous medium to form an emulsion dispersion comprising emulsified particles;
converging the emulsified particles to granulate mother toner particles, comprising controlling a temperature of the emulsion dispersion to control a circularity of the mother toner particles; and
removing the organic solvent,
wherein the resin component comprises a crystalline resin in an amount not less than 50% by weight, and the mother toner particles have an average circularity of from 0.940 to 0.980.
